(19) United States
(12) Patent Application Publication
(10) Pub. No.: US 2024/0337526 A1
(43) Pub. Date: Oct. 10, 2024

(54) SENSOR AND METHOD FOR DETERMINING RELATIVE MOTION BETWEEN TWO OBJECTS

(71) Applicant: Nanyang Technological University, Singapore (SG)

(72) Inventors: Qing ZHANG, Singapore (SG); Wei Bin SEH, Singapore (SG); Yin SUN, Singapore (SG); Ran XU, Singapore (SG); Joseph Sylvester CHANG, Singapore (SG)

(73) Assignee: Nanyang Technological University, Singapore (SG)

(21) Appl. No.: 18/743,916

(22) Filed: Jun. 14, 2024

Related U.S. Application Data
(63) Continuation-in-part of application No. PCT/SG2023/050214, filed on Mar. 30, 2023.

(30) Foreign Application Priority Data
Mar. 30, 2022 (SG) 10202203249Y
Jan. 15, 2024 (SG) 10202400119V

(51) Int. Cl. G01H 11/06; G01M 7/02; G01M 13/045; G01P 3/48

(52) U.S. Cl. CPC G01H 11/06; G01M 7/025; G01M 13/045; G01P 3/4802

(57) ABSTRACT

According to embodiments of the present invention, a sensor for determining relative motion between two objects is provided. The sensor includes a primary sensing part including a single primary electrode or multiple primary electrodes; a secondary sensing part including a single secondary electrode or multiple secondary electrodes; and one or more electrical measurement units. Each electrical measurement unit may be electrically coupled to a ground and one of the followings: the single primary electrode, a common electrical connection or separate electrical connections of the multiple primary electrodes, the single secondary electrode, a common electrical connecting point or separate electrical connecting points of the multiple secondary electrodes; or electrically coupled between two primary electrodes, or between two secondary electrodes. According to further embodiments, a method for determining at least one quantifiable parameter of relative motion between a movable object and a stationary object or another movable object is also provided.

### CROSS-REFERENCE TO RELATED APPLICATION

This application claims the benefit of priority of Singapore Patent Application No. 10202400119V, filed Jan. 15, 2024, and is a continuation in part of International Patent Application No. PCT/SG2023/050214, filed Mar. 3, 2023, which claims priority to Singapore Patent Application No. 10202203249Y, filed Mar. 30, 2022. The content of which are hereby incorporated by reference in their entireties.

### TECHNICAL FIELD

Various embodiments relate to a sensor, more specifically, a relative reciprocating motion sensor, and a method for determining at least one quantifiable parameter of relative motion between a movable object and a stationary object or another movable object.

### BACKGROUND

Detection of relative reciprocating motions, including reciprocating motion speeds, frequencies, amplitudes, and directions, amongst others is in high demand in many fields as reciprocating motions are fundamental in industrial fabrication processes, transportation, and so on. Irregular reciprocating motions are often associated with machinery wear and tear and misalignment, amongst others. Therefore, monitoring relative reciprocating motions of a mechanism may provide us with the working conditions of a mechanical system.

Reciprocating motions may be detected using several well-established methods, including piezoelectric, electrostatic, magnetic, and optical techniques. In a piezoelectric sensor, a piezoelectric element is sandwiched between a seismic mass and a structure base. The force of inertia of the mass under impact of reciprocating motions may create a strain to the piezoelectric element, producing a piezoelectric signal that is a function of the reciprocating motion frequency, amplitude, and so on. As the piezoelectric element is subject to mechanical impact, a drastic impact might damage it. In addition, the piezoelectric sensing element needs to be in contact with the reciprocating motional sources. It is not capable of detecting the gap width between a reciprocating movable part and a stationary part.

A typical electrostatic sensor contains a pair of electrodes under a voltage difference. One of the electrodes may be attached to a flexible reed and the other may be fixed to a stationary part. When reciprocating motions translate to the flexible reed, the air gap between the two electrodes or the capacitance of the two electrodes varies to generate an alternating current (AC), which provides the information of reciprocating motion frequency and amplitude and the transient gap width. Electrostatic sensors are of high sensitivity, generating a high output even at a low frequency. However, an external voltage is required between the two electrodes. Alternatively, a layer of electret may be introduced to one of the electrodes or the two electrodes may be of distinct work functions, ϕ₂ and ϕ₁, where a built-in potential difference qV₁₂=ϕ₂−ϕ₁ exists in between the two electrodes once they are connected electrically. When the movable electrode moves repeatedly, an AC is created in the external circuit. As the two electrodes are connected electrically, this type of electrostatic sensor is not capable of detecting the eccentricity of a rotor with respect to a stator.

To monitor the rotation status of a rotor or the gap between a rotor and a stator, magnetic sensors, including Hall effect sensors, linear variable differential transformers (LVDTs) and eddy current sensors, amongst others are widely employed in the industry.

A Hall effect sensor consists merely of a rectangular semiconductor slab with a continuous current passing through it. By attaching a permanent magnet to a rotor or one side of a variable gap and placing the semiconductor slab on the stationary part or the other part of the gap, the Hall voltage may be detected, and it is a sensitive function of the gap width.

In an LVDT, a primary movable wire coiled around a piece of magnetically permeable material may be suspended in between a pair of identical secondary wire coils which is fixed on a stationary part. In operation, a constant amplitude alternating current is supplied to the primary coil to create a magnetic field so that the magnetic flux through the permeable material is coupled to the two adjacent secondary wire coils. If the primary coil is out of the midway between the two secondary wire coils, a differential electromotive force, emf, in the two secondary wire coils is created and used to monitor the motions of the primary coil. The output usually requires no amplification. LVDTs are popular for detection of vibrations larger than 4 mm. For smaller vibrations, eddy current sensors are more commonly used.

An eddy current sensor consists merely of a wire coil. A high-frequency magnetic field is generated by feeding a high-frequency current to the wire coil. When a moving conductive object is within the magnetic field, an eddy current is induced in the object, and then produces a magnetic flux that in turn increases the impedance of the wire coil. From the resultant oscillation signals, the vibration amplitude and frequency may be deduced. Magnetic field-based sensors are immune to temperature variation. However, one needs to maintain high-frequency currents through the wire coils, which is costly and inconvenient, especially for on-site monitoring. In addition, the measurements usually show large drift, where compensation is regularly required. Moreover, to ensure the maximum sensitivity, the sensing surface needs to be maintained perpendicular to the magnetic field. As a result, constant calibration may be required throughout the period when such magnetic field-based sensors are in use.

Light beam position sensors and optical mice are the two major optical sensors to detect relative motions. A light beam position sensor measures the light beam positions. A change in the light beam position tells the relative motions between the position sensor and the light source or the object which reflects the light beam. The beam position sensors are of high sensitivity and able to detect static and dynamic relative positions. However, a high level of optical alignment is required. In addition, beam position sensors are insensitive to the motions along the light beam. An optical mouse processes the optical flow of the mouse pad images taken by the optical mouse to determine the relative motion between the optical mouse and mouse pad. Although optical mice are user-friendly, they require a flat mouse pad to create clear images and image processing, they may not be feasible for fast and real-time monitoring.

Thus, there is a need for a novel method and apparatus for on-site monitoring of relative reciprocating motions between two objects, including, but not limited to detections of the relative motion speed, vibration amplitude and frequency, the transient gap width, rotor eccentricity, amongst others, that address at least the problems mentioned above.

### SUMMARY

According to an embodiment, a sensor is provided. The sensor may include a primary sensing part including a single primary electrode or multiple primary electrodes; a secondary sensing part including a single secondary electrode or multiple secondary electrodes; and one or more electrical measurement units. The single primary electrode may include a first material and a second material electrically coupled to the first material, the first material being different from the second material. The multiple primary electrodes may include two or more primary electrodes, at least some of the multiple primary electrodes including one primary electrode material or different primary electrode materials. The multiple primary electrodes may be electrically coupled to one another to form a common electrical connection or each of the multiple primary electrodes may be electrically coupled to one or more of the multiple primary electrodes to form separate electrical connections. The single secondary electrode may include a third material and a fourth material electrically coupled to the third material, the third material being different from the fourth material. The multiple secondary electrodes may include two or more secondary electrodes, at least some of the multiple secondary electrodes including one secondary electrode material or different secondary electrode materials. The multiple secondary electrodes may be electrically coupled to one another to form a common electrical connecting point or each of the multiple secondary electrodes may be electrically coupled to one or more of the multiple secondary electrodes to form separate electrical connecting points. The one or more electrical measurement units each may be electrically coupled to: the single primary electrode and a ground, or one primary electrode of the multiple primary electrodes and another primary electrode of the multiple primary electrodes, or the common electrical connection of the multiple primary electrodes and the ground, or the separate electrical connections of the multiple primary electrodes and the ground, or the single secondary electrode and the ground, or one secondary electrode of the multiple secondary electrodes and another secondary electrode of the multiple secondary electrodes, or the common electrical connecting point of the multiple secondary electrodes and the ground, or the separate electrical connecting points of the multiple secondary electrodes and the ground. The primary sensing part and the secondary sensing part may be free from electrical connection with each other. The single primary electrode or at least one of the multiple primary electrodes may be configured to be attached to a movable object, and the single secondary electrode or at least one of the multiple secondary electrodes may be configured to be fixed to a stationary object or another movable object. The primary sensing part may be arranged to be spaced apart from the secondary sensing part within an electrostatic interaction range. The single primary electrode or the at least one of the multiple primary electrodes and the single secondary electrode or the at least one of the multiple secondary electrodes may be arranged to move relatively to each other to generate one or more electrical signals measurable by the one or more electrical measurement units, the generated one or more electrical signals being representative of at least one quantifiable parameter of relative motion between the primary sensing part and the secondary sensing part.

According to an embodiment, a method for determining at least one quantifiable parameter of relative motion between a movable object and a stationary object or another movable object is provided. The method may include providing a sensor including a primary sensing part including a single primary electrode or multiple primary electrodes, a secondary sensing part including a single secondary electrode or multiple secondary electrodes, and one or more electrical measurement units; attaching the single primary electrode or at least one of the multiple primary electrodes to the movable object; attaching the single secondary electrode or at least one of the multiple secondary electrodes to the stationary object or the other movable object, with the single secondary electrode or the at least one of the multiple secondary electrodes positioned facing towards the single primary electrode or the at least one of the multiple primary electrodes such that the primary sensing part is spaced apart from the secondary sensing part within an electrostatic interaction range; and measuring, by the one or more electrical measurement units, one or more electrical signals generated in the sensor, wherein the generated one or more electrical signals is representative of the at least one quantifiable parameter of relative motion between the primary sensing part and the secondary sensing part. The single primary electrode may include a first material and a second material electrically coupled to the first material, the first material being different from the second material. The multiple primary electrodes may include two or more primary electrodes, at least some of the multiple primary electrodes including one primary electrode material or different primary electrode materials. The multiple primary electrodes may be electrically coupled to one another to form a common electrical connection or each of the multiple primary electrodes may be electrically coupled to one or more of the multiple primary electrodes to form separate electrical connections. The single secondary electrode may include a third material and a fourth material electrically coupled to the third material, the third material being different from the fourth material. The multiple secondary electrodes may include two or more electrodes, at least some of the multiple secondary electrodes including one secondary electrode material or different secondary electrode materials. The multiple secondary electrodes may be electrically coupled to one another to form a common electrical connecting point or each of the multiple secondary electrodes may be electrically coupled to one or more of the multiple secondary electrodes to form separate electrical connecting points. The one or more electrical measurement units each may be electrically coupled to: the single primary electrode and a ground, or one primary electrode of the multiple primary electrodes and another primary electrode of the multiple primary electrodes, or the common electrical connection of the multiple primary electrodes and the ground, or the separate electrical connections of the multiple primary electrodes and the ground, or the single secondary electrode and the ground, or one secondary electrode of the multiple secondary electrodes and another secondary electrode of the multiple secondary electrodes, or the common electrical connecting point of the multiple secondary electrodes and the ground, or the separate electrical connecting points of the multiple secondary electrodes and the ground. The primary sensing part and the secondary sensing part may be free from electrical connection with each other.

### BRIEF DESCRIPTION OF THE DRAWINGS

In the drawings, like reference characters generally refer to like parts throughout the different views. The drawings are not necessarily to scale, emphasis instead generally being placed upon illustrating the principles of the invention. In the following description, various embodiments of the invention are described with reference to the following drawings, in which:

FIG. 1 shows a schematic view of a sensor, according to various embodiments.

FIG. 2 shows a schematic view of a sensor, according to other embodiments.

FIG. 3 shows a schematic view illustrating an elementary structure of the sensor of FIG. 2, in which a primary sensing part has Electrodes AL and AH and a secondary sensing part has Electrodes BL and BH, according to one example.

FIG. 4A shows a schematic view illustrating a structure of the sensor of FIG. 2, in which a primary sensing part has Electrodes A1, A2 and A3 attached onto a rotor and a secondary sensing part has Electrodes B1, B2 and B3 fixed to a stator, according to one example.

FIG. 4B shows a schematic view illustrating a structure of the sensor of FIG. 2, in which a primary sensing part has Electrodes A1, A2 and A3 attached onto a rotor and a secondary sensing part has Electrodes B1, B2 and B3 fixed to a stator, according to another example.

FIG. 4C shows a schematic view illustrating a structure of the sensor of FIG. 2, in which a primary sensing part has Electrodes A1, A2 and A3 attached onto a rotor and secondary sensing parts have Electrodes B1, B2, B3 and B4 fixed to a stator, according to another example.

FIG. 5 shows a schematic view illustrating a structure of the sensor of FIG. 3, with electrodes coated with passivation layers, according to one example.

FIG. 6 shows a schematic view illustrating a structure of the sensor of FIG. 5, including built-in potential difference multipliers (BPDMs) and electrodes coated with passivation layers, according to one example.

FIG. 7 shows a schematic view illustrating a structure of the sensor of FIG. 4C, including built-in potential difference multipliers (BPDMs), according to one example.

FIG. 8 shows a flow chart illustrating a method for determining at least one quantifiable parameter of relative motion between a movable object and a stationary object or another movable object, according to various embodiments.

FIG. 9 shows a schematic view illustrating an exemplary arrangement where a sensor is used to monitor the linear motion speed of a movable part with respect to a stationary part or another movable part and the gap width between them, wherein each electrode of the sensor is coupled to a BPDM.

FIG. 10 shows a schematic view illustrating an exemplary arrangement where a sensor is used to monitor the vibration amplitude and frequency of a vibrational beam (the movable part), in a form of a comb structure, with respect to a stationary base or another movable object (the stationary part).

FIGS. 11 to 15 show schematic views illustrating a series/sequence of stills involving relative rectilinear motions between the primary and secondary sensing parts of a sensor, more specifically, depicting several relative positions of Electrodes AL and AH of the primary sensing part with respect to Electrodes BL and BH of the secondary sensing part under the corresponding displacements, according to one example.

FIG. 16 shows a graph illustrating the transient current generated during a relative reciprocating motion of Electrodes AL and AH of the primary sensing part with respect to Electrodes BL and BH electrodes of the secondary sensing part, described using FIGS. 11 to 15, under zero eccentricity.

FIG. 17 shows a graph illustrating several transient currents generated during the relative reciprocating motion of Electrodes AL and AH with respect to Electrodes BL and BH under different eccentricities, according to one example.

FIG. 18 shows a graph illustrating the peak current difference between the first positive current peak and the second positive current peak in one motion cycle shown in FIG. 17 as a function of the eccentricity.

FIG. 19 shows a schematic view of a sensor of FIGS. 11 to 15, with a BPDM coupled to or being incorporated into Electrode BL, according to one example.

FIG. 20 shows a graph illustrating the transient currents enhanced by the BPDM coupled to or being incorporated into Electrode BL, as shown in FIG. 19.

FIG. 21 shows a schematic view of a sensor of FIGS. 11 to 15, with a BPDM coupled to or being incorporated into Electrode BH, according to one example.

FIG. 22 shows a graph illustrating the transient currents enhanced by the BPDM coupled to or being incorporated into Electrode BH, as shown in FIG. 21.

FIG. 23 shows a schematic view of a sensor of FIGS. 11 to 15, with a BPDM coupled between Electrodes AH and AL, according to one example.

FIG. 24 shows a graph illustrating the transient currents enhanced by the BPDM coupled between Electrodes AH and AL, as shown in FIG. 23.

FIG. 25 shows a graph illustrating several transient currents generated during the relative reciprocating motion of Electrodes AL and AH of the primary sensing part with respect to Electrodes BL and BH of the secondary sensing part with different eccentricities, according to one example, wherein Electrodes BL and BH of the secondary sensing part on the stationary object have the same electrode material, i.e., stainless steel.

FIG. 26 shows a schematic view illustrating a sensor in which Electrodes A1 and A2 of the primary sensing part are installed to a rotor, and Electrodes B1 and B2 of the secondary sensing part are fixed to a stator, according to one example.

FIG. 27 shows a graph illustrating several transient currents generated during rotation of Electrodes A1 and A2 of the primary sensing part with respect to Electrodes B1 and B2 of the secondary sensing part depicted in FIG. 26, under different eccentricities.

FIG. 28 shows a schematic view illustrating the sensor of FIG. 26, in which a BPDM is incorporated to Electrode B2 in the secondary sensing part, with the eccentricity being set to zero, according to one example.

FIG. 29 shows a graph depicting the BPDM enhancement effect on the transient currents acquired by the sensor of FIG. 28.

FIG. 30 shows a schematic view illustrating the sensor of FIG. 26, in which a BPDM is incorporated to Electrode B1 in the secondary sensing part, with the eccentricity being set to zero, according to one example.

FIG. 31 shows a graph depicting the BPDM enhancement effect on the transient currents acquired by the sensor of FIG. 30.

FIG. 32 shows a schematic view illustrating the sensor of FIG. 26, in which a BPDM is incorporated to Electrode A2 in the primary sensing part, with the eccentricity being set to zero, according to one example.

FIG. 33 shows a graph depicting the BPDM enhancement effect on the transient currents acquired by the sensor of FIG. 32.

FIG. 34 shows a schematic view illustrating a sensor modified from the sensor of FIG. 26 in which Electrodes A1 and A2 of the primary sensing part are installed to a rotor, and two identical Electrodes B1 of the secondary sensing part are fixed to a stator, with the eccentricity being set to zero, according to one example.

FIG. 35 shows a graph illustrating the transient currents generated during rotation of Electrodes A1 and A2 of the primary sensing part with respect to the two identical Electrodes B1 of the secondary sensing part depicted in FIG. 34.

FIG. 36 shows a schematic view illustrating a sensor modified from the sensor of FIG. 26 in which Electrodes A1 and A2 of the primary sensing part are installed to a rotor at the locations so that a smaller angle between the two virtual lines from the rotor centre to the two electrode centers is approximately 90°, and Electrodes B1 and B2 of the secondary sensing part are fixed to a stator, with the eccentricity being set to zero, according to one example.

FIG. 37 shows a graph illustrating the transient currents generated during rotation of Electrodes A1 and A2 of the primary sensing part with respect to Electrodes B1 and B2 of the secondary sensing part depicted in FIG. 36.

FIG. 38 shows a schematic view illustrating a sensor modified from the sensor of FIG. 26 in which only one Electrode A2 (connected to another piece of material that is not shown in FIG. 38) of the primary sensing part is installed to a rotor, and Electrodes B1 and B2 of the secondary sensing part are fixed to a stator, with the eccentricity being set to zero, according to one example.

FIG. 39 shows the transient currents generated during rotation of Electrode A2 of the primary sensing part with respect to Electrodes B1 and B2 of the secondary sensing part depicted in FIG. 38.

### DETAILED DESCRIPTION

The following detailed description refers to the accompanying drawings that show, by way of illustration, specific details, and embodiments in which the invention may be practiced. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the methods or devices are analogously valid for the other methods or devices. Similarly, embodiments described in the context of a method are analogously valid for a device, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the phrase “at least substantially” may include “exactly” and a reasonable variance.

In the context of various embodiments, the term “about” or “approximately” as applied to a numeric value encompasses the exact value and a reasonable variance.

As used herein, the term “and/or” includes any and all combinations of one or more of the associated listed items.

As used herein, the phrase of the form of “at least one of A or B” may include A or B or both A and B. Correspondingly, the phrase of the form of “at least one of A or B or C”, or including further listed items, may include any and all combinations of one or more of the associated listed items.

As used herein, the expression “configured to” may mean “constructed to” or “arranged to”.

Various embodiments may provide a sensor and method for relative reciprocating motion detection. The sensor, more specifically, a relative reciprocating motion sensor, and a method may be for determining at least one quantifiable parameter of relative reciprocating motion between a primary sensing part of the sensor and a secondary sensing part of the sensor. In other words, the sensor may detect the relative reciprocating motion of the primary sensing part with respect to the secondary sensing part. The sensor may be for on-site monitoring of relative reciprocating motions. Along with the method, the sensor may find a broad spectrum of applications, including determination of relative reciprocating motion speed, vibration amplitude and frequency, transient gap width between the two parts, eccentricity of a rotor, amongst others. The sensor may be self-powered using the different physical properties of the electrodes of the primary sensing part and secondary sensing part, like the work function difference of the electrode materials, according to one example. The sensor may also be externally powered by incorporating batteries or supercapacitors or other electric power sources to enhance the transient currents induced by the relative motion.

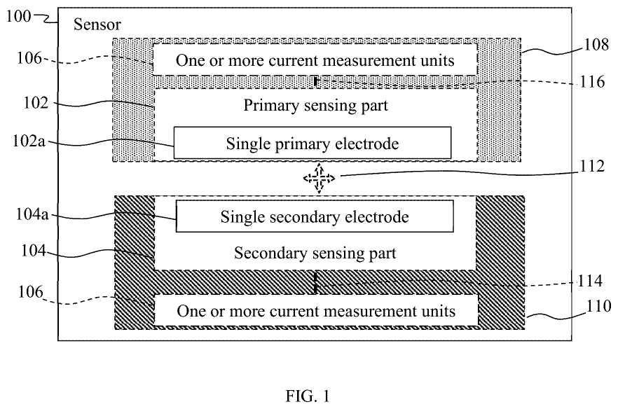

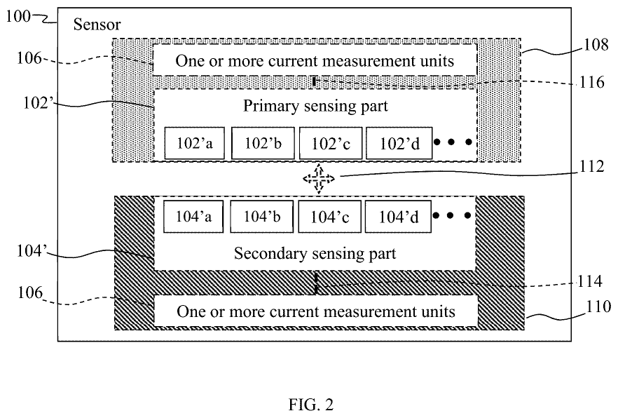

FIGS. 1 and 2 show schematic views of a sensor 100, according to various embodiments. The sensor 100 may include a primary sensing part 102, 102′ including a single primary electrode 102a (FIG. 1) or multiple primary electrodes 102′a, 102′b, 102′c, 102′d (FIG. 2); a secondary sensing part 104, 104′ including a single secondary electrode 104a (FIG. 1) or multiple secondary electrodes 104′a, 104′b, 104′c, 104′d (FIG. 2); and one or more electrical measurement units 106.

The single primary electrode 102a may include a first material and a second material electrically coupled to the first material, the first material being different from the second material. The first material and the second material may be different in terms of physical (e.g. electrical) properties.

The multiple primary electrodes 102′a-102′d may include two or more primary electrodes. Although four numeral references 102′a, 102′b, 102′c, and 102′d are used representatively in FIG. 2, it should be understood and appreciated that the number of multiple primary electrodes is not limited to only four primary electrodes. At least some of the multiple primary electrodes 102′a-102′d may include one primary electrode material or different primary electrode materials. In some embodiments, some or all of the multiple primary electrodes 102′a-102′d may be made of the same primary electrode material. In other embodiments, some or all of the multiple primary electrodes 102′a-102′d may be made of different primary electrode materials. In yet other embodiments, each of the multiple primary electrodes 102′a-102′d may be made of a primary electrode material different from that of another one of the multiple primary electrodes 102′a-102′d in term of physical (e.g. electrical) properties.

The multiple primary electrodes 102′a-102′d may be electrically coupled to one another to form a common electrical connection or each of the multiple primary electrodes 102′a-102′d may be electrically coupled to one or more of the multiple primary electrodes 102′a-102′d to form separate electrical connections.

The single secondary electrode 104a may include a third material and a fourth material electrically coupled to the third material, the third material being different from the fourth material. The third material and the fourth material may be different in terms of physical (e.g. electrical) properties.

The multiple secondary electrodes 104′a-104′d may include two or more secondary electrodes. Although four numeral references 104′a, 104′b, 104′c, and 104′d are used representatively in FIG. 2, it should be understood and appreciated that the number of multiple secondary electrodes is not limited to only four secondary electrodes. At least some of the multiple secondary electrodes 104′a-104′d may include one secondary electrode material or different secondary electrode materials. In some embodiments, some or all of the multiple secondary electrodes 104′a-104′d may be made of the same secondary electrode material. In other embodiments, some or all of the multiple secondary electrodes 104′a-104′d may be made of different secondary electrode materials. In yet other embodiments, each of the multiple secondary electrodes 104′a-104′d may be made of a secondary electrode material different from that of another one of the multiple secondary electrodes 104′a-104′d in term of physical (e.g. electrical) properties.

The multiple secondary electrodes 104′a-104′d may be electrically coupled to one another to form a common electrical connecting point, or each of the multiple secondary electrodes 104′a-104′d may be electrically coupled to one or more of the multiple secondary electrodes 104′a-104′d to form separate electrical connecting points.

The one or more electrical measurement units 106 may each be electrically coupled (as denoted by a line 116 or a line 114) to: the single primary electrode 102a and a ground, or one primary electrode of the multiple primary electrodes 102′a-102′d and another primary electrode of the multiple primary electrodes 102′a-102′d (i.e. the one or more electrical measurement units 106 being electrically coupled between one of the multiple primary electrodes 102′a-102′d and another of the multiple primary electrodes 102′a-102′d), or the common electrical connection of the multiple primary electrodes 102′a-102′d and the ground, or the separate electrical connections of the multiple primary electrodes 102′a-102′d and the ground, or the single secondary electrode 104a and the ground, or one secondary electrode of the multiple secondary electrodes 104′a-104′d and another secondary electrode of the multiple secondary electrodes 104′a-104′d (i.e. the one or more electrical measurement units 106 being electrically coupled between one of the multiple secondary electrodes 104′a-104′d and another of the multiple primary electrodes 104′a-104′d), or the common electrical connecting point of the multiple secondary electrodes 104′a-104′d and the ground, or the separate electrical connecting points of the multiple secondary electrodes 104′a-104′d and the ground.

The primary sensing part 102, 102′ and the secondary sensing part 104, 104′ may be free from electrical connection with each other. The primary sensing part 102, 102′ may be arranged to be spaced apart from the secondary sensing part 104, 104′ within an electrostatic interaction range.

The single primary electrode 102a or at least one of the multiple primary electrodes 102′a-102′d may be configured to be attached to a movable object 108, and the single secondary electrode 104a or at least one of the multiple secondary electrodes 104′a-104′d may be configured to be fixed to a stationary object 110 or another movable object 110.

The single primary electrode 102a or the at least one of the multiple primary electrodes 102′a-102′d and the single secondary electrode 104a or the at least one of the multiple secondary electrodes 104′a-104′d may be arranged to move relatively to cach other (as denoted by a multi-directional arrow 112) to generate one or more electrical signals measurable by the one or more electrical measurement units 106. The generated one or more electrical signals may be representative of at least one quantifiable parameter of relative motion between the primary sensing part 102, 102′ and the secondary sensing part 104, 104′.

In various embodiments, each of the one or more electrical measurement units 106 may include an ammeter or a current detector, a current preamplifier, a voltmeter, a voltage detector, or a voltage amplifier, amongst others. For example, each of the one or more electrical signals may include one or more current signals, or one or more voltage signals, or one or more signals caused by the one or more current signals, or the one or more voltage signals, amongst others.

In the context of various embodiments, the term “multiple” means two or more.

The phrase “free from electrical connection” means having no wire connection between the primary sensing part 102, 102′ and the secondary sensing part 104, 104′.

The expression “electrically coupled” means having an electrical conduction path or being in electrical communication. “Electrically coupled” may refer to a direct or indirect electrical connection.

The expression “quantifiable parameter of relative motion” may include relative motion speed, or vibration amplitude, or vibration frequency, or transient gap width between the two parts, eccentricity of a rotor, rotational speed, the gap between a rotor and a stator or others. For example, relative motion may include relative reciprocating motion that is a repetitive up-and-down or back-and-forth linear motion.

The terms “attached to” and “fixed to” may be interchangeable and may also refer to as coupled to, connected to, in communication with, or hosted on.

In other words, the sensor (e.g. 100) may include the primary sensing part (e.g. 102, 102′) including one (single) electrode (e.g. 102a) or two (double) electrodes (e.g. 102′a, 102′b) or multiple electrodes (e.g. 102′a-102′d), wherein the single electrode may be coupled to another metal/semiconductor material whose work function is different from the electrode material, and wherein the two electrodes or the multiple electrodes may be electrically coupled separately or together, and the electrodes may include the same materials or may include different materials. In the case of multiple electrodes, some of the electrodes may have the same materials and these (same materials) electrodes may have different materials from the rest of the electrodes. The sensor may also include the secondary sensing part (e.g. 104, 104′) including one (single) electrode (e.g. 104a) or two (double) electrodes (e.g. 104′a, 104′b) or multiple electrodes (e.g. 104′a-104′d), wherein the single electrode may be coupled to another metal/semiconductor material whose work function is different from the electrode material, and wherein the two electrodes or the multiple electrodes may be electrically coupled separately or together, and the electrodes may include the same materials or may include different materials. In the case of multiple electrodes in the secondary sensing part, some of the electrodes may have the same materials and these (same materials) may have different materials from the rest of the electrodes. The sensor may further include the one or more electrical measurement units (e.g. 106) cach electrically coupled to: each of the electrodes in the primary sensing part and a ground, or the common electrical connection of several or all electrodes in the primary sensing and a ground, or each of the electrodes in the secondary sensing part and a ground, or the common electrical connection of several or all electrodes in the secondary sensing and a ground. For example, the one or more electrical measurement units may be an electrical measurement unit electrically coupled to the single electrode or one of the double electrodes or their electrical connection or one of the multiple electrodes or their electrical connection in the secondary sensing part and the ground. In other examples, the one or more electrical measurement units may be an electrical measurement unit electrically coupled to the single electrode or one of the double electrodes or their electrical connection or one of the multiple electrodes or their electrical connection in the primary sensing part and the ground. In yet other examples, the one or more electrical measurement units may be an electrical measurement unit electrically coupled to one or more electrode(s) in the secondary sensing part, and another electrical measurement unit electrically coupled to one or more electrode(s) in the primary sensing part. The electrodes may be arranged near to each other within the electrostatic interaction range and move relatively to each other to generate one or more electrical signals measurable by the one or more electrical measurement units. For example, the sensor (e.g. 100) may be for on-site monitoring of relative reciprocating motions. In such an example, the one electrode or at least one of the two electrodes or at least one of the multiple electrodes of the primary sensing part and the one electrode or at least one of the two electrodes or at least one of the multiple electrodes of the secondary sensing part may be arranged to reciprocate relatively to each other to generate one or more electrical signals measurable by the one or more electrical measurement units, the generated one or more electrical signals being representative of at least one quantifiable parameter of the relative reciprocating motion between the primary sensing part and the secondary sensing part.

In various embodiments, the sensor 100 may be a self-powered sensor, or an externally powered sensor. For the externally powered sensor, an external power source may be coupled to the single secondary electrode 104a or the multiple secondary electrodes 104′a-104′d in the secondary sensing part 104, 104′ that may be usually fixed to a stationary object.

The first material, the second material, the third material, the fourth material, the primary electrode material, or the secondary electrode material may include at least one of the following: a metal, a semiconductor, a ferroelectric material, an electret, or a pyroelectric material. The different primary electrode materials and the different secondary electrode materials may have different work functions, or different ferroelectric properties, or different electret properties, or different pyroelectric properties. The different primary electrode materials, or the different secondary electrode materials may include at least one of the following: a metal, a semiconductor, a ferroelectric material, an electret, or a pyroelectric material.

In other words, the materials involved in each of electrodes in the primary and secondary sensing parts (e.g. 102, 102′, 104, 104′) may include metals, or semiconductors, or ferroelectric materials, or electrets, or pyroelectric materials or a combination of these materials. More specifically, each electrode may include at least one metal, or at least one semiconductor, or at least one ferroelectric material, or at least one pyroelectric material, or a combination of at least one metal, and/or the at least one semiconductor, and/or the at least one ferroelectric material, and/or the at least one pyroelectric material. The material selection for the electrodes in the primary sensing part (e.g. 102, 102′) and secondary sensing part (e.g. 104, 104′) may be determined by the materials involved in other electrodes of the same sensing part and/or the materials involved in the electrodes of the other sensing part.

It should be noted that the term “metal”, described herein with respect to the sensor 100 according to various embodiments, refers to all types of metallic materials. The metal(s) may be of different dimensionalities and geometries, including in bulk, thin films and an assembly of micro-, nano-sized metallic layers, wires and particles, and so on. They may be hard or flexible.

In the context of various embodiments, the term “semiconductor” means all types of intrinsic and doped semiconducting materials, including inorganic semiconductors and organic semiconductors, regardless of their crystalline or amorphous atomic structures. The semiconductors may be of different dimensionalities and geometries, including in bulk, thin films, and an assembly of micro-, nano-sized semiconducting layers, wires, and particles, and so on. They may be hard or flexible.

In the context of various embodiments, the term “ferroelectric material” means all types of ferroelectric materials, including inorganic and organic, regardless of their crystalline or amorphous atomic structures. The ferroelectric materials may be of different dimensionalities and geometries, including in bulk, thin films, and an assembly of micro-, nano-sized semiconducting layers, wires, and particles, and so on. They may be hard or flexible.

In the context of various embodiments, the term “electret” means all types of electrets, including inorganic and organic, regardless of their crystalline or amorphous atomic structures. The electrets may be of different dimensionalities and geometries, including in bulk, thin films, and an assembly of micro-, nano-sized semiconducting layers, wires, and particles, and so on. They may be hard or flexible.

In the context of various embodiments, the term “pyroelectric material” means all types of pyroelectric materials, including inorganic and organic, regardless of their crystalline or amorphous atomic structures. The pyroelectric materials may be of different dimensionalities and geometries, including in bulk, thin films, and an assembly of micro-, nano-sized semiconducting layers, wires, and particles, and so on. They may be hard or flexible.

For better understanding but not limited to in any way, the electrode(s) in the primary and secondary sensing parts 102, 102′, 104, 104′ may be constructed from pure metal plates and semiconductor wafers or may be made by depositing pure metallic or doped semiconducting materials onto supporting substrates by physical or chemical processes. The substrates may be insulating, conductive, rigid, flexible, amongst others. For example, the single primary electrode 102a or the single secondary electrode 104a may contain two or more different types of electrets. The multiple primary electrodes 102′a-102′d or the multiple secondary electrodes 104′a-104′d may contain two or more different types of electrets.

Selection of the materials for each electrode may affect or may be dependent on the configurations or arrangements of other electrodes in the primary and secondary sensing parts 102, 102′, 104, 104′. This may be further exemplified in some of the embodiments discussed herein later on below.

In various embodiments, the multiple primary electrodes 102′a-102′d configured to be attached to the movable object may be positioned at pre-determined distance(s) apart from one another. The multiple secondary electrodes 104′a-104′d configured to be fixed to the stationary object or another movable object may be positioned at pre-determined distance(s) apart from one another. In effect, at least one of the multiple primary electrodes 102′a-102′d may be configured to reciprocate relative to at least one of the multiple secondary electrodes 104′a-104′d, with a space apart from the other, but near or facing to each other.

The single primary electrode 102a may be configured to reciprocate relative to the single secondary electrode 104a, with a space apart from the other, but near or facing to each other.

In various embodiments, the one or more electrical measurement units 106, and the single primary electrode 102a or the multiple primary electrodes 102′a-102′d may be arranged in at least one of the following configurations: the one or more electrical measurement units 106 being electrically coupled between the ground and the single primary electrode 102a; or the one or more electrical measurement units 106 being electrically coupled between the ground and the multiple primary electrodes 102′a-102′d at the common electrical connection; or the one or more electrical measurement units 106 being electrically coupled between the ground and at least some of the multiple primary electrodes 102′a-102′d at the respective separate electrical connections; or the one or more electrical measurement units 106 being electrically coupled between one or more of the multiple primary electrodes 102′a-102′d and another one or more of the multiple primary electrodes 102′a-102′d.

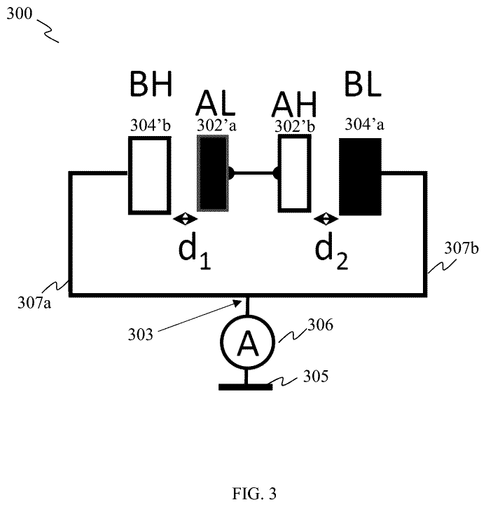

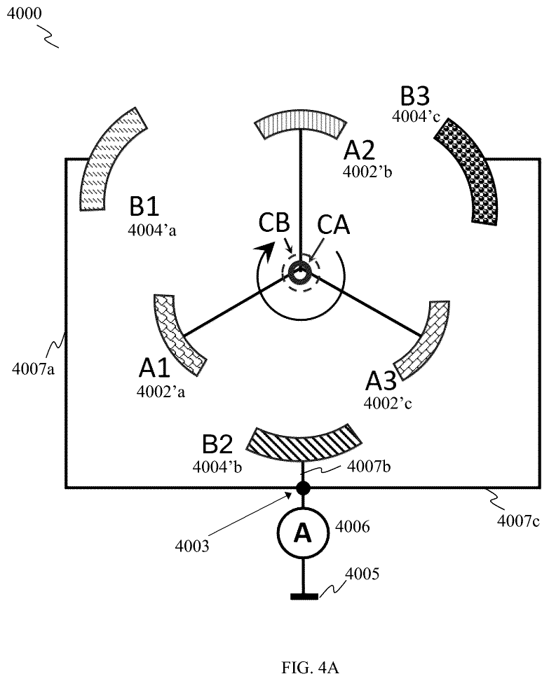

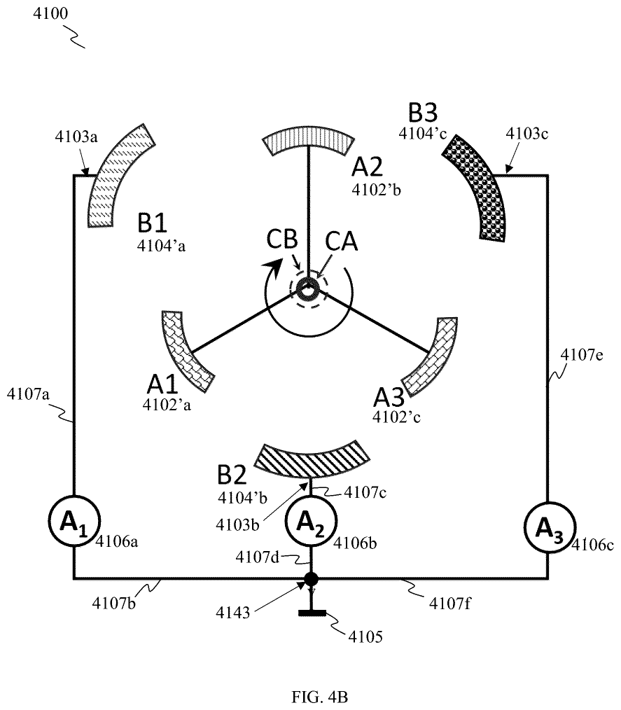

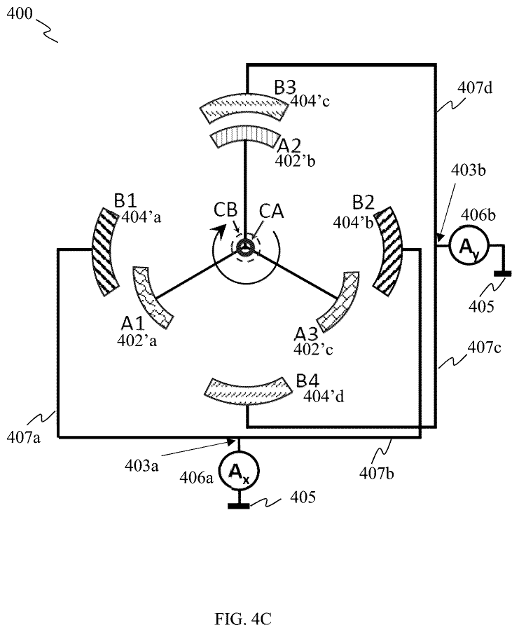

The one or more electrical measurement units 106, and the single secondary electrode 104a or the multiple secondary electrodes 104′a-104′d may be arranged in at least one of the following configurations: the one or more electrical measurement units 106 being electrically coupled between the ground and the single secondary electrode 104a (not shown in figures); or the one or more electrical measurement units 106 being electrically coupled between the ground and the multiple secondary electrodes 104′a-104′d at the common electrical connecting point (e.g. see FIG. 3 and FIG. 4A); or the one or more electrical measurement units 106 being electrically coupled between the ground and at least some of the multiple secondary electrodes 104′a-104′d at the respective separate electrical connecting points (e.g. see FIG. 4B); or the one or more electrical measurement units 106 being electrically coupled between one or more of the multiple secondary electrodes 104′a-104′d and another one or more of the multiple secondary electrodes 104′a-104′d, e.g. without connecting the one or more electrical measurement units 106 to the ground (not shown in figures).

Each of the one or more electrical measurement units 106 may be configured to condition or measure or both condition and measure the generated one or more electrical signals.

Each of the one or more electrical measurement units 106 may have either: single-ended inputs including: an input and the ground, or differential inputs comprising: a non-inverting input and an inverting input.

In one example, for the single-ended inputs, the electrical measurement unit 106 may be coupled in between the single primary electrode 102a and the ground, or in between the multiple primary electrodes 102′a-102′d at the common electrical connection and the ground, or each of the one or more electrical measurement units 106 may be coupled in between each electrical connection of at least some of the multiple primary electrodes 102′a-102′d and the ground.

In another example, for the single-ended inputs, the electrical measurement unit 106 may be coupled in between the single secondary electrode 104a and the ground, or in between the multiple secondary electrodes 104′a-104′d at the common electrical connecting point and the ground, or each of the one or more electrical measurement units 106 may be coupled in between each electrical connecting point of at least some of the multiple secondary electrodes 104′a-104′d and the ground.

In a different example, for the differential inputs, one of the multiple primary electrodes 102′a-102′d may be connected to the non-inverting input, and another one of the multiple primary electrodes 102′a-102′d may be connected to the inverting input.

In yet another example, for the differential inputs, one of the multiple secondary electrodes 104′a-104′d may be connected to the non-inverting input, and another one of the multiple secondary electrodes 104′a-104′d may be connected to the inverting input.

Different structures of the sensor 100 and the methodologies for detecting relative motions using the sensor 100 may also be provided according to various embodiments.

As discussed above, an embodiment may provide for the one or more electrical measurement units 106 to be electrically coupled between the ground and the multiple secondary electrodes 104′a-104′d at the common electrical connecting point. Such embodiments may be illustrated in FIGS. 3 and 4A, showing schematic views of elementary structures of the sensor 300 and the sensor 4000, respectively, according to different examples. The sensor 300, 4000 may include the same or like elements or components as those of the sensor 100 of FIG. 2, and as such, similar ending numerals are assigned and the like elements may be as described in the context of the sensor 100 of FIG. 2, and therefore some corresponding descriptions may be omitted here.

In FIG. 3, the sensor 300 includes Electrodes AL 302′a and AH 302′b in a primary sensing part, Electrodes BL 304′a and BH 304′b in a secondary sensing part and an electrical measurement unit 306. Electrode AL 302′a may contain the same or different materials from Electrode AH 302′b. For example, in a case of different materials, Electrode AL 302′a may have a lower work function as compared to Electrode AH 302′b (having higher work function). Electrode AL 302′a is connected to Electrode AH 302′b electrically. Electrodes AL 302′a and AH 302′b may be attached to a reciprocating object (not shown in FIG. 3) with a fixed distance between them. Electrode BL 304′a may contain the same or different materials from Electrode BH 304′b. For example, in a case of different materials, Electrode BL 304′a may have a lower work function as compared to Electrode AH 304′b (having higher work function). Electrode BL 304′a is connected to Electrode BH 304′b. Electrodes BL 304′a and BH 304′b may be attached to a stationary object or another movable object (not shown in FIG. 3) with a fixed distance between them. The electrical measurement unit 306 is electrically coupled to the wire connection of Electrodes BL 304′a and BH 304′b at a common electrical connecting point 303 and the ground 305. More specifically, a wire 307a may be arranged to electrically connect Electrode BH 304′b to the common electrical connecting point 303 and another wire 307b may be arranged to electrically connect Electrode BL 304′a to the same common electrical connecting point 303. One terminal (e.g. the positive terminal) of the electrical measurement unit 306 is electrically coupled to the common electrical connecting point 303 and the other terminal (e.g. the negative terminal) of the electrical measurement unit 306 is electrically coupled to the ground 305. There is no electrical wire connection or no electrical contact between the primary and the secondary sensing parts. Electrode BL 304′a in the secondary sensing part is facing or near to Electrode AH 302′b in the primary electrode pair, while Electrode BH 304′b in the secondary sensing part may be facing or near to Electrode AL 302′a in the primary sensing part, as illustrated in FIG. 3. The primary sensing part may be arranged in between Electrodes BL 304′a and BH 304′b of the secondary sensing part. Electrodes AH 302′b and AL 302′a of the primary sensing part are configured to collectively move relatively to Electrodes BL 304′a and BH 304′b of the secondary sensing part, resulting in the variation of gap width d₂ or d₁ or the misalignment of Electrodes AH 302′b and AL 302′a with Electrodes BL 304′a and BH 304′b, alternating currents, AC, or voltages, or electrical signals are generated in each electrode pair 302′a, 302′b, 304′a, 304′b. The electrical signal in the secondary sensing part may be measured using the electrical measurement unit 306 and it provides the information of the relative reciprocating motion between the moveable object and the stationary object or another movable object.

In FIG. 4A, the primary sensing part contains three electrodes, i.e., A1 4002′a, A2 4002′b and A3 4002′c, which are electrically coupled together and installed on a rotor of a motor or a bearing, etc. whose rotation axis is CA. Electrodes A1 4002′a, A2 4002′b and A3 4002′c may contain the same or different metals, or semiconductors, or ferroelectric materials, or electrets, or pyroelectric materials, and so on. The secondary sensing part contains three electrodes, i.e., B1 4004′a, B2 4004′b and B3 4004′c, which are installed on a stator of the motor or the bearing, etc. whose geometric centre is CB. CA may or may not be overlapped with CB as an example in FIG. 4A. Electrodes B1 4004′a, B2 4004′b and B3 4004′c are electrically connected. An electrical measurement unit A 4006 is coupled between the ground 4005 and a common electrical connecting point 4003 of Electrodes B1 4004′a, B2 4004′b and B3 4004′c. More specifically, a wire 4007a may be arranged to electrically connect Electrode B1 4004′a to the common electrical connecting point 4003, another wire 4007b may be arranged to electrically connect Electrode B2 4004′b to the same common electrical connecting point 4003 and yet another wire 4007c may be arranged to electrically connect Electrode B3 4004′c to this common electrical connecting point 4003. One terminal (e.g. the positive terminal) of the electrical measurement unit A 4006 is electrically coupled to the common electrical connecting point 4003 and the other terminal (e.g. the negative terminal) of the electrical measurement unit A 4006 is electrically coupled to the ground 4005. Electrodes B1 4004′a, B2 4004′b and B3 4004′c may contain the same or different metals, or semiconductors, or ferroelectric materials, or electrets, or pyroelectric materials, and so on. As one example, if one of Electrodes A1 4002′a, A2 4002′b and A3 4002′c contains different materials from one or both of the other two primary electrodes, then Electrodes B1 4004′a, B2 4004′b and B3 4004′c may contain the same materials, or one of B1 4004′a, B2 4004′b and B3 4004′c may contain different materials from one or both of the other two secondary electrodes. There is no electrical wire connection or no electrical contact between any Electrodes A1 4002′a, A2 4002′b and A3 4002′c of the primary sensing part and any Electrodes B1 4004′a, B2 4004′b and B3 4004′c of the secondary sensing part. The three Electrodes A1 4002′a, A2 4002′b and A3 4002′c of the primary sensing part are configured to collectively rotate relatively to Electrodes B1 4004′a, B2 4004′b and B3 4004′c of the secondary sensing part. This configuration may allow the electrical measurement unit 4006 to measure the electrical signals associated with the eccentricity of the rotation axis of the rotor, and rotation speed with improved sensitivity.

As discussed above, an embodiment may provide for the one or more electrical measurement units 106 to be electrically coupled between the ground and at least some of the multiple secondary electrodes 104′a-104′d at the respective separate electrical connecting points. In other words, cach electrical measurement units 106 may be coupled to each of the multiple secondary electrodes 104′a-104′d at the respective separate electrical connecting points. Such embodiments may be illustrated in FIG. 4B showing a schematic view of a structure of the sensor 4100, according to one example. The sensor 4100 may include the same or like elements or components as those of the sensor 100 of FIG. 2, and as such, similar ending numerals are assigned and the like elements may be as described in the context of the sensor 100 of FIG. 2, and therefore some corresponding descriptions may be omitted here.

In FIG. 4B, the primary sensing part contains three electrodes, i.e., A1 4102′a, A2 4102′b and A3 4102′c, which are electrically coupled together and installed on a rotor of a motor or a bearing, etc. whose rotation axis is CA. Electrodes A1 4102′a, A2 4102′b and A3 4102′c may contain the same or different metals, or semiconductors, or ferroelectric materials, or electrets, or pyroelectric materials, and so on. The secondary sensing part contains Electrodes, B1 4104′a, B2 4104′b and B3 4104′c, which are installed on a stator of the motor or the bearing, etc. whose geometric centre is CB. CA may or may not be overlapped with CB as an example in FIG. 4B. The secondary sensing part of FIG. 4B may refer to an example of a single primary sensing part with three primary electrodes and a single secondary sensing part with three secondary electrodes. It should be appreciated that in other examples, the secondary sensing part may contain more than three secondary electrodes, and the primary sensing part may contain more than three primary electrodes. In FIG. 4B, Electrodes B1 4104′a, B2 4104′b and B3 4104′c are electrically connected. An electrical measurement unit A1 4106a is coupled between one separate electrical connecting point 4103a of Electrode B1 4104′a and the ground 4105. An electrical measurement unit A2 4106b is coupled between another separate electrical connecting point 4103b of Electrode B2 4104′b and the ground 4105. An electrical measurement unit A3 4106c is coupled between yet another separate electrical connecting point 4103c of Electrode B3 4104′c and the ground 4105. More specifically, a wire 4107a may be arranged to electrically connect Electrode B1 4104′a at the separate electrical connecting point 4103a to one terminal (e.g. the positive terminal) of the electrical measurement unit A1 4106a and another wire 4107b may be arranged to electrically connect the other terminal (e.g. the negative terminal) of the electrical measurement unit A1 4106a to the ground 4105. A wire 4107c may be arranged to electrically connect Electrode B2 4104′b at the other separate electrical connecting point 4103b to one terminal (e.g. the positive terminal) of the electrical measurement unit A2 4106b and another wire 4107d may be arranged to electrically connect the other terminal (e.g. the negative terminal) of the electrical measurement unit A2 4106b to the ground 4105. A wire 4107e may be arranged to electrically connect Electrode B3 4104′c at the yet another separate electrical connecting point 4103c to one terminal (e.g. the positive terminal) of the electrical measurement unit A3 4106c and another wire 4107f may be arranged to electrically connect the other terminal (e.g. the negative terminal) of the electrical measurement unit A3 4106c to the ground 4105. The other wires 4107b, 4107d, 4107f may be connected together to a same point 4143 at or leading to the ground 4105. Electrodes B1 4104′a, B2 4104′b and B3 4104′c may contain the same or different metals, or semiconductors, or ferroelectric materials, or electrets, or pyroelectric materials, and so on. Material-wise, Electrodes A1 4102′a, A2 4102′b and A3 4102′c as well as Electrodes B1 4104′a, B2 4104′b and B3 4104′c of FIG. 4B may be described in similar context to Electrodes A1 4002′a, A2 4002′b and A3 4002′c as well as Electrodes B1 4004′a, B2 4004′b and B3 4004′c of FIG. 4A, respectively. There is no electrical wire connection or no electrical contact between any Electrodes A1 4102′a, A2 4102′b and A3 4102′c of the primary sensing part and any Electrodes B1 4104′a, B2 4104′b and B3 4104′c of the secondary sensing part. The three Electrodes A1 4102′a, A2 4102′b and A3 4102′c of the primary sensing part are configured to collectively rotate relatively to Electrodes B1 4104′a, B2 4104′b and B3 4104′c of the secondary sensing part. This configuration may allow the electrical measurement units 4106a, 4106b, 4106c to measure the electrical signals associated with the eccentricity of the rotation axis of the rotor in a first direction, a second direction and a third direction, respectively, in addition to the rotation speed with improved sensivity. The first, second and third directions may be angularly spaced apart from one another.

In various embodiments, the sensor 100 may further include one or more tertiary sensing parts each including a single tertiary electrode or multiple tertiary electrodes. The single tertiary electrode may include a fifth material and a sixth material electrically coupled to the fifth material, the fifth material being different from the sixth material. The multiple tertiary electrodes may include two or more tertiary electrodes, at least some of the multiple tertiary electrodes including one tertiary electrode material or different tertiary electrode materials. The multiple tertiary electrodes may be electrically coupled to one another to form a common electrical connecting node, or each of the multiple tertiary electrodes may be electrically coupled to one or more of the multiple tertiary electrodes to form separate electrical connecting nodes. The single tertiary electrode or at least one of the multiple tertiary electrodes may be configured to be fixed to the stationary object 110 or the other movable object 110 and may be arranged spaced apart (or angularly spaced apart) from the single secondary electrode 104a or the at least one of the multiple secondary electrodes 104′a-104′d when fixed to the stationary object 110 or the other movable object 110. The one or more electrical measurement units 106 each may be electrically coupled to: the single tertiary electrode and the ground, or one tertiary electrode of the multiple tertiary electrodes and another tertiary electrode of the multiple tertiary electrodes, or the common electrical connecting node of the multiple tertiary electrodes and the ground, or the separate electrical connecting nodes of the multiple tertiary electrodes and the ground. The primary sensing part 102 may be arranged to be spaced apart from the one or more tertiary sensing parts within the electrostatic interaction range. The single primary electrode 102a or the at least one of the multiple primary electrodes 102′a-102′d and the single tertiary electrode or the at least one of the multiple tertiary electrodes may be arranged to move relatively to each other to generate one or more subsidiary electrical signals measurable by the one or more electrical measurement units 106.

Each of the one or more tertiary sensing parts may be considered as additional secondary sensing parts 104, 104′ since they effectively work in the same manner. Thus, for each tertiary sensing part, the single tertiary electrode and the multiple tertiary electrodes may be described in similar context with the single secondary electrode 104a and the multiple secondary electrodes 104′a-104′d, respectively. The single tertiary electrode and the multiple tertiary electrodes may also adopt the characteristics and parameters of the single secondary electrode 104a and the multiple secondary electrodes 104′a-104′d, respectively, as described above.

For example, the one or more tertiary sensing parts may be used for measuring eccentricity of a rotor in two or more different directions.

As discussed above, various embodiments may provide a sensor with one or more tertiary sensing parts. Such embodiments may be illustrated in FIG. 4C showing a schematic view of a structure of the sensor 400, according to one example. The sensor 400 may include the same or like elements or components as those of the sensor 100 of FIG. 2, and as such, similar ending numerals are assigned and the like elements may be as described in the context of the sensor 100 of FIG. 2, and therefore some corresponding descriptions may be omitted here.

In FIG. 4C, the primary sensing part contains three electrodes, i.e., A1 402′a, A2 402′b and A3 402′c, which are electrically coupled together and installed on a rotor of a motor or a bearing, etc. whose rotation axis is CA. Electrodes A1 402′a, A2 402′b and A3 402′c may contain the same or different metals, or semiconductors, or ferroelectric materials, or electrets, or pyroelectric materials, and so on. One secondary sensing part and one tertiary sensing part (or interchangeably referred to as two secondary sensing parts) are installed on the stator of the motor or the bearing, etc. whose geometric centre is CB. The secondary sensing part contains Electrodes B1 404′a and B2 404′b and the tertiary sensing part contains Electrodes B3 404′c and B4 404′d, CA may or may not be overlapped with CB as an example in FIG. 4C. Electrodes B1 404′a and B2 404′b are electrically connected. An electrical measurement unit Aₓ 406a is coupled between the electrical connection of Electrodes B1 404′a (via a wire 407a) and B2 404′b (via another wire 407b) at one common electrical connecting point 403a and the ground 405. Electrodes B3 404′c and B4 404′d are electrically connected. An electrical measurement unit A_{y} 406b is coupled between the electrical connection of Electrodes B3 404′c (via a wire 407d) and B4 404′d (via another wire 407c) at another common electrical connecting point (node) 403b and the ground 405. The common electrical connecting point 403a and the other common electrical connecting point (node) 403b may be different (distinct) points. Electrodes B1 404′a, B2 404′b, B3 404′c and B4 404′d may contain the same or different metals, or semiconductors, or ferroelectric materials, or electrets, or pyroelectric materials, and so on. As one example, if one of Electrodes A1 402′a, A2 402′b and A3 402′c contains different materials from one or both of the other two electrodes, then Electrodes B1 404′a, B2 404′b, B3 404′c and B4 404′d may contain the same materials, or Electrodes B1 404′a and B2 404′b contain the same materials which may be different from the materials of Electrodes B3 404′c and B4 404′d. There is no electrical wire connection or no electrical contact between any Electrodes A1 402′a, A2 402′b and A3 402′c of the primary sensing part and any Electrodes B1 404′a, B2 404′b, B3 404′c and B4 404′d of the secondary sensing part and the tertiary sensing part. The three Electrodes A1 402′a, A2 402′b and A3 402′c of the primary sensing part are configured to collectively rotate relatively to the two double Electrodes B1 404′a and B2 404′b as well as B3 404′c and B4 404′d of the secondary sensing parts. This configuration may allow the electrical measurement unit 406a and the other electrical measurement unit 406b to measure the electrical signals associated with the eccentricity of the rotation axis of the rotor in a x (horizontal) direction and in a y (vertical) direction, respectively, in addition to the rotation speed. The x and y directions may be orthogonal to each other.

In various embodiments, the single primary electrode 102a or the multiple primary electrodes 102′a-102′d each has a front surface coated with passivation layers, the front surface being a surface arranged to be respectively positioned facing to the single secondary electrode 104a or each of the multiple secondary electrodes 104′a-104′d. In other words, each electrode in the primary sensing part 102, 102′ may have a front surface coated with passivation layers, the front surface being a surface arranged to be respectively positioned facing to an electrode in the secondary sensing part 104, 104′. The passivation layers coated to each electrode may or may not be the same as those coated to other electrodes in the primary sensing part 102, 102′.

In various embodiments, the single secondary electrode 104a or the multiple secondary electrodes 104′a-104′d each has a frontal surface coated with passivation layers, the frontal surface being a surface arranged to be respectively positioned facing to the single primary electrode 102a or each of the multiple primary electrodes 102′a-102′d. That is to say, each electrode in the secondary sensing part 104, 104′ may have a front surface coated with passivation layers, the front surface being a surface arranged to be respectively positioned facing to an electrode in the primary sensing part 102, 102′. The passivation layers coated to each electrode may or may not be the same as those coated to other electrodes in the secondary sensing part 104, 104′.

In other embodiments, the passivation layers coated to each of the electrodes in the primary sensing part 102, 102′ and the secondary sensing part 104, 104′ may be different from each other or may be the same correspondingly. The materials of the passivation layers may be dielectrics, or polymers, or functionalized groups, or metals, or semiconductors, or ferroelectric materials, or electrets, or pyroelectric materials or a combination of at least one of these materials. The passivation layers may reduce the density of surface states of the electrodes, passivate the surfaces of the electrodes from oxidation and/or contamination, enhance the induced electrical signals, amongst others. For example, the passivation layers may include dielectric materials, such as silicon dioxide (SiO₂), silicon nitride (Si₃N₄), aluminium oxide (Al₂O₃), hafnium dioxide (HfO₂), and so on. Alternatively, the passivation layers may include thin semiconductor layers or thin metal layers, including tungsten (W), cobalt (Co), palladium (Pd), aluminium (Al), silver (Ag), platinum (Pt), and so on. The passivation layers may also include chemical modification layers where functional groups may be introduced to the surfaces of the electrodes in favour of the better performances of the sensors described herein.

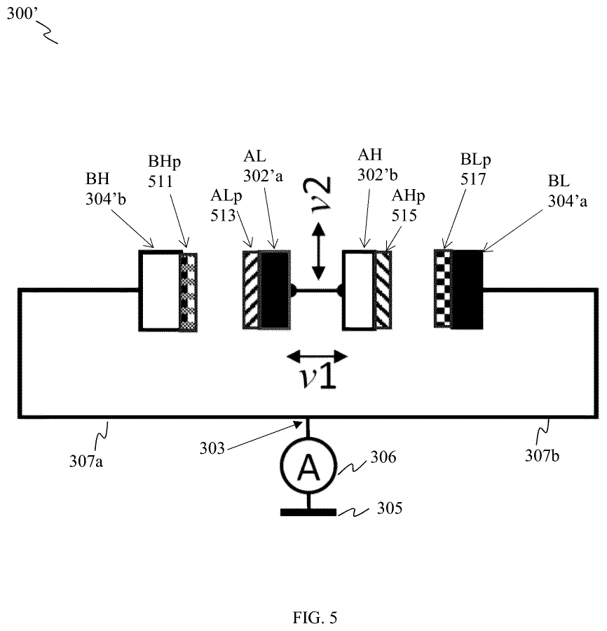

FIG. 5 shows a schematic view of the sensor 300′, that is based on the sensor 300 of FIG. 3, where all four electrodes AL 302′a, AH 302′b, BL 304′a and BH 304′b (described in similar context with the electrodes in the primary sensing part 102′, and the electrodes in the secondary sensing part 104′ of FIG. 2, respectively) are coated with passivation layers ALp 513, AHp 515, BLp 517 and BHp 511, respectively, on the front surface of each electrode, according to one example. The front surfaces of the electrodes in the primary sensing part (e.g. 102, 102′) and/or the secondary sensing part (e.g. 104, 104′) may be respectively coated with the passivation layers ALp 513, AHp 515, BLp 517 and BHp 511 in order to reduce the surface states and prevent the front surfaces from oxidation and/or contamination. Passivation layers ALp 513, AHp 515, BLp 517 and BHp 511 may be the same or may be different in terms of the coating materials. At least one of Electrode AL 302′a or Electrode AH 302′b may move relatively to at least one of Electrode BH 304′b or Electrode BL 304′a in one or both directions v1, v2. Relative motions may provide the horizontal and/or vertical offsets between the primary and the secondary sensing parts, creating a transient current that may be measured using the electrical measurement unit 306 coupled to the connection of Electrodes BL 304′a and BH 304′b and the ground 305.

In various embodiments, the sensor 100 may further include one or more built-in potential difference multipliers (BPDMs). The one or more built-in potential difference multipliers may be electrically coupled to the single primary electrode 102a or the multiple primary electrodes 102′a-102′d. Additionally or alternatively, the one or more built-in potential difference multipliers may be electrically coupled to the single secondary electrode 104a or the multiple secondary electrodes 104′a-104′d. For example, the one or more BPDMs may be electrically coupled to one or several or all electrodes in the primary sensing part and/or one or several or all electrodes in the secondary sensing part. The one or more electrical signals generated by the relative motions between the primary sensing part and the secondary sensing part may be amplified by the one or more BPDMs.

The one or more BPDMs may include one or more components coupled in series, each component including: a first portion including a metal, or a semiconductor, or a ferroelectric material, or a pyroelectric material, or a functionalized material; and a second portion including another metal, or another semiconductor, or another ferroelectric material, or another pyroelectric material, or another functionalized material, wherein the second portion is adjacent to the first portion. Alternatively, the one or more BPDMs may include one or more diodes coupled in series, one or more semiconductor junctions (like p-n, p-i-n, Sckottky junctions, etc.) coupled in series; or one or more energy storage devices coupled in series.

In the context of the one or more BPDMs being one or more components, an insulating spacer may be arranged between each component of the one or more components and a neighbouring component of the one or more components. In other words, each component may be separated from its neighbouring component(s) with the insulating spacer(s). For example, the insulating spacer may include an air gap or an insulating material. Insulating spacers (or simply referred herein as spacers) may be introduced to separate the couples (or interchangeably referred to as component) in the BPDM(s). The spacers may be simply air gaps or insulating materials, such as polymers, porous organosilicate glass, amongst others.

For or in each component, an interlayer may be arranged between the first portion and the second portion to enhance the electrical signals. The interlayer(s) may also be introduced in between the first portion and the second portion through physical or chemical processes. Thus, the interlayers may be metals or semiconductors, semimetals, conductive materials, ferroelectric materials, pyroelectric materials, functionalized materials, amongst others.

In other words, the BPDM may contain one component (or interchangeably referred to as couple) or multiple couples of materials. For example, the two materials in each couple may intimately contact each other or be bonded together through an interlayer. The two materials are in effect electrically connected. In between the couples, or more specifically, two adjacent couples, an insulating spacer may be introduced. All the couples may be electrically connected in series through a metal wire or electric connection. For example, the metal or semiconductor the first portion may have a work function, and the other metal or semiconductor may have another work function different from the work function of the metal or semiconductor of the first portion. Examples of the arrangements of spacers and/or interlayers for the one or more BPDMs of the sensor 100 may be similarly described in the international application no. PCT/SG2023/050214.

In the case of more than one BPDM, the BPDMs may be the same or different, and may include various passive components so that the sensor 100 functions based on the self-powered mode.

The one or more BPDMs may be replaced with batteries, supercapacitors and other external power sources so that the sensor 100 functions based on the external-powered mode.

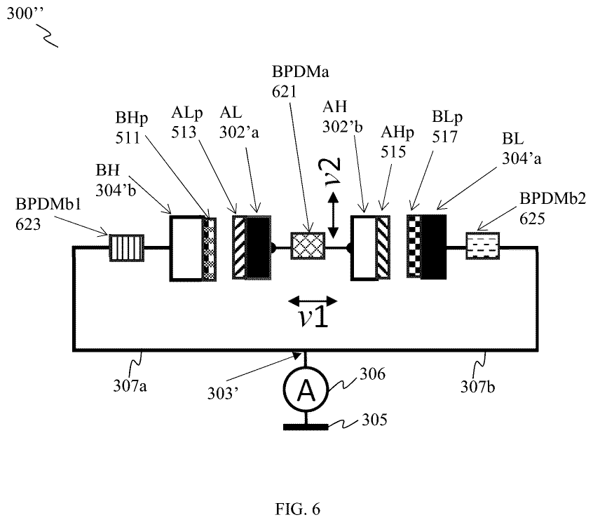

FIG. 6 shows a schematic view of the sensor 300″, that is based on the sensor 300′ of FIG. 5, where all four electrodes AL 302′a, AH 302′b, BL 304′a and BH 304′b (described in similar context with the electrodes in the primary sensing part 102′, the electrodes in the secondary sensing part 104′ of FIG. 2, respectively) are coated with passivation layers ALp 513, AHp 515, BLp 517 and BHp 511, and with BPDMs, according to one example. As seen in the general structure of the sensor 300″ of FIG. 6, the sensor 300″ includes a primary sensing part of Electrodes AL 302′a and AH 302′b and a secondary sensing part of Electrodes BL 304′a and BH 304′b. BPDMa 621 is connected to Electrodes AL 302′a and AH 302′b of the primary sensing part. BPDMb1 623 is introduced in between Electrode BH 304′b and the input terminal of the electrical measurement unit 306. BPDMb2 625 is introduced in between Electrode BL 304′a and the input terminal of the electrical measurement unit 306. The other terminal of the electrical measurement unit 306 is connected to the ground 305. Alternatively, the wire connection between BPDMb1 623 and BPDMb2 625 may be connected to the ground 305 through the electrical measurement unit 306. In FIG. 6, the wire connection may be considered a common electrical connecting point 303′ formed by one end of the wire 307a having the other end (of the wire 307a) being electrically coupled to Electrode BH 304′b via BPDMb1 623 arranged in series, one end of the wire 307b having the other end (of the wire 307b) being electrically coupled to Electrode BL 304′a via BPDMb2 625 arranged in series, and one terminal (e.g. the positive terminal) of the electrical measurement unit 306 with the other terminal (e.g. the negative terminal) electrically coupled to the ground 305. The generated electrical signal measured by the electrical measurement unit 306 may be amplified due to employment of BPDMa 621 and/or BPDMb1 623 and/or BPDMb2 625. With incorporating BPDMa 621 to Electrodes AL 302′a and AH 302′b of the primary sensing part, Electrodes AL 302′a and AH 302′b may contain the same materials. With incorporating BPDMb1 623 and/or BPDMb2 625 to Electrodes BH 304′b and BL 304′a of the secondary sensing part, Electrodes BH 304′b and BL 304′a may contain the same materials.

In various embodiments, the single tertiary electrode or the multiple tertiary electrodes each may have a fore surface coated with passivation layers, the fore surface being a surface arranged to be respectively positioned facing to the single primary electrode 102a or each of the multiple primary electrodes 102′a-102′d.

The sensor 100 may further include one or more built-in potential difference multipliers electrically coupled to the single tertiary electrode or the multiple tertiary electrodes.

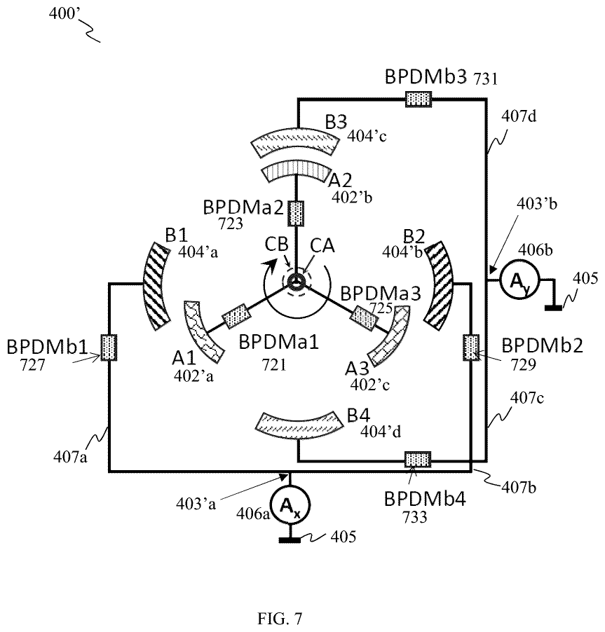

FIG. 7 shows a schematic view of the sensor 400′ that is based on the sensor 400 of FIG. 4C, in which all Electrodes A1 402′a, A2 402′b and A3 402′c in the primary sensing part, Electrodes B1 404′a and B2 404′b of the secondary sensing part, and B3 404′c and B4 404′d of the tertiary sensing part (the secondary sensing part and the tertiary sensing part may collectively be referred to as two secondary sensing parts) are connected to BPDMs, according to one example. As seen in the general structure of the sensor 400′ of FIG. 7, BPDMa1 721, BPDMa2 723 and BPDMa3 725 are coupled to Electrodes A1 402′a, A2 402′b and A3 402′c in the primary sensing part, respectively. BPDMb1 727, BPDMb2 729, BPDMb3 731 and BPDMb4 733 are coupled to Electrodes B1 404′a, B2 404′b, B3 404′c and B4 404′d of the secondary sensing parts, respectively. More specifically, a wire 407a may be arranged to electrically connect Electrode B1 404′a (via BPDMb1 727 arranged in series) to a common electrical connecting point 403′a and another wire 407b may be arranged to electrically connect Electrode B2 404′b (via BPDMb2 729 arranged in series) to the same common electrical connecting point 403′a. One terminal (e.g. the positive terminal) of the electrical measurement unit Aₓ 406a is electrically coupled to the common electrical connecting point 403′a and the other terminal (e.g. the negative terminal) of the the electrical measurement unit Aₓ 406a is electrically coupled to the ground 405. A wire 407c may be arranged to electrically connect Electrode B4 404′d (via BPDMb4 733 arranged in series) to another common electrical connecting point 403′b and another wire 407d may be arranged to electrically connect Electrode B3 404′c (via BPDMb3 731 arranged in series) to the same other common electrical connecting point 403′b. One terminal (e.g. the positive terminal) of the electrical measurement unit A_{y} 406b is electrically coupled to the other common electrical connecting point 403′b and the other terminal (e.g. the negative terminal) of the the electrical measurement unit A_{y} 406b is electrically coupled to the ground 405. The common electrical connecting point 403′a and the other common electrical connecting point 403′b may be different (distinct) points. The generated electrical signals measured by the two electrical measurement unit Aₓ 406a and A_{y} 406b may be amplified due to employment of one or several or all of the BPDMs. Under this configuration, Electrodes A1 402′a, A2 402′b and A3 402′c may contain the same materials. Electrodes B1 404′a, B2 404′b, B3 404′c and B4 404′d may contain the same materials, which may be the same as or may be different from the materials for Electrodes A1 402′a, A2 402′b and A3 402′c.

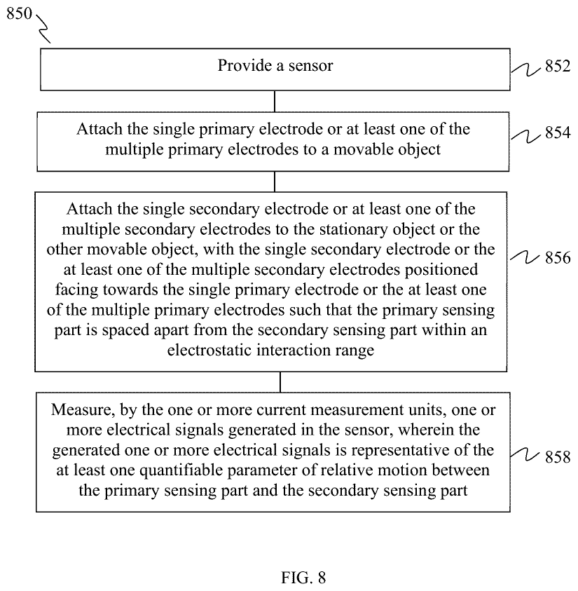

FIG. 8 shows a flow chart illustrating a method 850 for determining at least one quantifiable parameter of relative motion between a movable object (e.g. 108 in FIGS. 1 and 2) and a stationary object or another movable object (e.g. 110 in FIGS. 1 and 2), according to various embodiments. As seen in FIG. 8, a sensor (e.g. 100) may be provided at Step 852. The sensor may include a primary sensing part (e.g. 102, 102′) including a single primary electrode (e.g. 102a) or multiple primary electrodes (e.g. 102′a-102′d); a secondary sensing part (e.g. 104, 104′) including a single secondary electrode (104a) or multiple secondary electrodes (e.g. 104′a-104′d); and one or more electrical measurement units (e.g. 106). The single primary electrode may include a first material and a second material electrically coupled to the first material, the first material being different from the second material. The multiple primary electrodes may include two or more primary electrodes, at least some of the multiple primary electrodes including one primary electrode material or different primary electrode materials. The multiple primary electrodes may be electrically coupled to one another to form a common electrical connection, or each of the multiple primary electrodes may be electrically coupled to one or more of the multiple primary electrodes to form separate electrical connections. The single secondary electrode may include a third material and a fourth material electrically coupled to the third material, the third material being different from the fourth material. The multiple secondary electrodes may include two or more electrodes, at least some of the multiple secondary electrodes including one secondary electrode material or different secondary electrode materials. The multiple secondary electrodes may be electrically coupled to one another to form a common electrical connecting point, or each of the multiple secondary electrodes may be electrically coupled to one or more of the multiple secondary electrodes to form separate electrical connecting points. The one or more electrical measurement units cach may be electrically coupled to: the single primary electrode and a ground, or one primary electrode of the multiple primary electrodes and another primary electrode of the multiple primary electrodes, or the common electrical connection of the multiple primary electrodes and the ground, or the separate electrical connections of the multiple primary electrodes and the ground, or the single secondary electrode and the ground, or one secondary electrode of the multiple secondary electrodes and another secondary electrode of the multiple secondary electrodes, or the common electrical connecting point of the multiple secondary electrodes and the ground, or the separate electrical connecting points of the multiple secondary electrodes and the ground. The primary sensing part and the secondary sensing part may be free from electrical connection with each other.

The sensor may include or may be described in similar context with the sensor 100 (FIG. 1 or 2), the sensor 300 (FIG. 3), the sensor 4000 (FIG. 4A), the sensor 4100 (FIG. 4B), the sensor 400 (FIG. 4C), the sensor 300′ (FIG. 5), the sensor 300″ (FIG. 6) or the sensor 400′ (FIG. 7), according to various embodiments and examples.

At Step 854 (FIG. 8), the single primary electrode or at least one of the multiple primary electrodes may be attached to the movable object. At Step 856, the single secondary electrode or at least one of the multiple secondary electrodes may be attached to the stationary object or the other movable object, with the single secondary electrode or the at least one of the multiple secondary electrodes positioned facing towards the single primary electrode or the at least one of the multiple primary electrodes such that the primary sensing part may be spaced apart from the secondary sensing part within an electrostatic interaction range. At Step 858, one or more electrical signals generated in or through the sensor may be measured by the one or more electrical measurement units, wherein the generated one or more electrical signals may be representative of the at least one quantifiable parameter of relative motion between the primary sensing part and the secondary sensing part.

In other words, a method for detecting relative motions between a movable object and a stationary object or another movable object using the sensor may be provided. At least one of the electrodes of the primary sensing part may be attached to the movable object, while at least one of the electrodes of the secondary sensing part may be fixed to the stationary object or the other movable object. There is no wire connection or electric connection between the electrode(s) of the primary sensing part and the electrode(s) of the secondary sensing part. The materials involved in the electrodes in the primary sensing part may be the same or different from one another in terms of the physical properties of the materials involved. The materials involved in the electrodes in the secondary sensing part may be the same or different from one another in terms of the physical properties of the materials involved. For example, the single electrode (in each of the primary sensing part or the secondary sensing part) may coupled to another metal/semiconductor material whose work function may be different from the electrode material. When the electrode(s) of the primary sensing part have or experience a relative motion with respect to the electrode(s) of the secondary sensing part in a range where electrostatic induction between them plays a role, electrical signals may be generated within the electrode(s) of the primary sensing part and within the electrode(s) of the secondary sensing part. The generated electrical signal(s) in the secondary sensing part or in the primary sensing part may be detected by the one or more electrical measurement units and may provide the information of the relative motion of the movable object with respect to the stationary object or the other movable object, including but not limited to, the relative motion speed, vibration amplitude and frequency, the transient gap width between them, rotor eccentricity, rotation speed, and so on. For example, the generated one or more electrical signals may be representative of the at least one quantifiable parameter of the relative reciprocating motion between the primary sensing part and the secondary sensing part. The generated or induced electrical signals may be converted from the mechanical power of the movable object through electrostatic induction without using external power. Thus, this sensor may be self-powered through mechanical to electric power conversion. In this sense, with appropriate minor adjustments of the device architectures, the sensor may be used to harvest the mechanical power of the movable object. Alternatively, the sensor may be externally powered.

Attaching the single primary electrode or at least one of the multiple primary electrodes to the movable object at Step 854 may cause the electrodes of the primary sensing part to be positioned at a pre-determined distance apart from each other. The pre-determined distance may be fixed or remain unchanged or may not be fixed when the sensor is in use. Attaching the single secondary electrode or at least one of the multiple secondary electrodes to the stationary object or the other movable object at Step 856 may cause the electrodes of the secondary sensing part to be positioned at a pre-defined distance apart from each other. The pre-defined distance may remain unchanged or may not be fixed when the sensor is in use. In effect, at least one electrode of the primary sensing part may be configured to collectively move relatively to at least one electrode of the secondary sensing part.

In some embodiments, attaching the single primary electrode or at least one of the multiple primary electrodes to the movable object at Step 854 may include attaching at least one electrode in the primary sensing part to the movable object with the electrode positioned facing towards or near to at least one electrode of the secondary sensing part. In these embodiments, measuring the one or more electrical signals at Step 858 may include measuring the one or more electrical signals representative of at least one of a relative motion speed or a gap width of the movable object with respect to the stationary object or the other movable object.

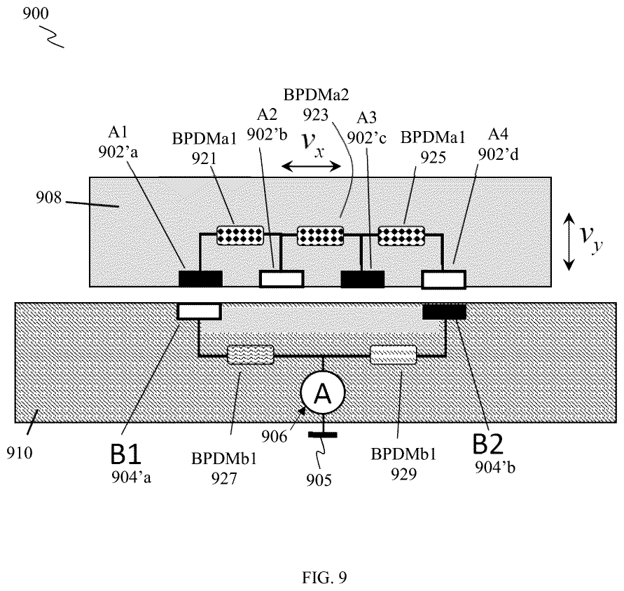

FIG. 9 shows a schematic view illustrating an exemplary arrangement where a sensor 900 is used to monitor the linear motion speed of a movable part with respect to a stationary part or another movable part and the gap width between them. The sensor 900 may include the same or like elements or components as those of the sensor 100 of FIG. 2, and as such, the same ending numerals are assigned and the like elements may be as described in the context of the sensor 100 of FIG. 1A, and therefore some corresponding descriptions may be omitted here. In the exemplary arrangement of FIG. 9, Electrodes A1 902′a, A2 902′b, A3 902′c and A4 902′d of the primary sensing part (e.g. 102′ of FIG. 2), together with three BPDMs (BPDMa1 921, BPDMa2 923, BPDMa3 925), may be attached to or hosted on a movable part 908. Electrodes B1 904′a and B2 904′b of the secondary sensing part (e.g. 104′ of FIG. 2), together with two BPDMs (BPDMb1 927 and BPDMb2 929) and an electrical measurement unit 906, may be fixed to a stationary part 910 or another movable part 910. The electrical measurement unit 906 may be arranged between the ground 905 and a connection point of BPDMb1 927 and BPDMb2 929. The four electrodes of the primary sensing part may be configured to collectively move relative to the two electrodes in the secondary sensing part. An electrical signal may be generated in between Electrodes B1 904′a and B2 904′b of the secondary sensing part if the electrodes of the primary sensing part move with respect to the electrodes of the secondary sensing part in parallel to the electrode surfaces (the vₓ direction in FIG. 9) or perpendicular to the electrode surfaces (the v_{y} direction in FIG. 9). The generated electrical signal in the secondary sensing part may provide the information of the relative motion speed of the movable object with respect to the stationary object or the other movable object and the gap width between them.

In other embodiments, the movable object (e.g. 108 of FIGS. 1 and 2) may include a rotor of a motor or a bearing or a joint of two mechanical parts, the stationary object (e.g. 110 of FIGS. 1 and 2) may include a stator of the motor, or a holder of the bearing, or an arm connected to the joint, and measuring the one or more electrical signals at Step 858 may include measuring the one or more electrical signals representative of at least one of a rotational speed or an eccentricity of the rotor or the bearing or the joint or gaps between the movable object and the stationary object.

Exemplary arrangements where a sensor 400 and sensor 400′ in FIGS. 4C and 7, respectively, may be used to monitor the eccentricity in the horizontal direction and vertical direction and the rotation speed of the rotor.

It should be appreciated that while FIGS. 4C and 7 relate to detection of the relative motions in the horizontal and vertical directions, the two double electrodes of the secondary sensing part may be arranged spaced apart from each other (in pairs) at any angles (including 90° shown in FIGS. 4C and 7), to monitor relative motions in various angular directions (not shown in FIGS. 4C and 7).

In some embodiments, the sensor may further include one or more tertiary sensing parts each including a single tertiary electrode or multiple tertiary electrodes (e.g. as shown in FIGS. 4C and 7). The single tertiary electrode may include a fifth material and a sixth material electrically coupled to the fifth material, the fifth material being different from the sixth material. The multiple tertiary electrodes may include two or more electrodes, at least some of the multiple tertiary electrodes including one tertiary electrode material or different tertiary electrode materials. The multiple tertiary electrodes may be electrically coupled to one another to form a common electrical connecting node, or each of the multiple tertiary electrodes may be electrically coupled to one or more of the multiple tertiary electrodes to form separate electrical connecting nodes. One or more electrical measurement units (e.g. 106 of FIG. 1 or 2) may be cach electrically coupled to: the single tertiary electrode and the ground, or one tertiary electrode of the multiple tertiary electrodes and another tertiary electrode of the multiple tertiary electrodes, the common electrical connecting node of the multiple tertiary electrodes and the ground, or the separate electrical connecting nodes of the multiple tertiary electrodes and the ground. The method 850 may further include attaching the single tertiary electrode or at least one of the multiple tertiary electrodes to the stationary object or the other movable object, with the single tertiary electrode or at least one of the multiple tertiary electrodes positioned facing towards the single primary electrode or the at least one of the multiple primary electrodes such that the primary sensing part may be spaced apart from the one or more tertiary sensing parts within the electrostatic interaction range, and the single tertiary electrode or the at least one of the multiple tertiary electrodes may be arranged spaced apart (or angularly spaced apart) from the single secondary electrode or the at least one of the multiple secondary electrodes when fixed to the stationary object or the other movable object; measuring, by the one or more electrical measurement units, one or more subsidiary electrical signals generated in the single tertiary electrode or each of the multiple tertiary electrodes; and determining the eccentricity of the rotor in two or more different directions based on the generated one or more subsidiary electrical signals and the generated one or more electrical signals.

As discussed above, each of the one or more tertiary sensing parts may be considered as additional secondary sensing parts (e.g. 104, 104′) since they effectively work in the same manner. In other words, the method 850 may involve additional set(s) of secondary sensing part(s), with the electrodes arranged spaced apart from one another at different angles to monitor relative motions in more than two different directions (also not shown in figures).

In some embodiments, the movable object may include a vibrational beam or a reciprocating movable object, the stationary object may include a base supporting the vibrational beam or a holder of the reciprocating movable object, and measuring the one or more electrical signals at Step 858 may include measuring the one or more electrical signals representative of at least one of a position variation amplitude or a frequency of the vibrational beam or the reciprocating movable object with respect to the stationary object or the other movable object near the vibrational beam or the reciprocating movable object.

For example, attaching the single primary electrode or the at least one of the multiple primary electrodes to the movable object at Step 854 may include attaching the single primary electrode or the at least one of the multiple primary electrodes to the vibrational beam or the reciprocating movable object, attaching the single secondary electrode or the at least one of the multiple secondary electrodes to the stationary object at Step 856 may include attaching the single secondary electrode or the at least one of the multiple secondary electrodes to the base supporting the vibrational beam or the holder of the reciprocating movable object, and the method 850 may further include arranging the single primary electrode or the at least one of the multiple primary electrodes facing to the single secondary electrode or the at least one of the multiple secondary electrodes.

In one embodiment, arranging the single primary electrode or the at least one of the multiple primary electrodes facing to the single secondary electrode or the at least one of the multiple secondary electrodes may further include arranging the single secondary electrode or the at least one of the multiple secondary electrodes between the single primary electrode or the at least one of the multiple primary electrodes to form a structure of interdigital electrodes.

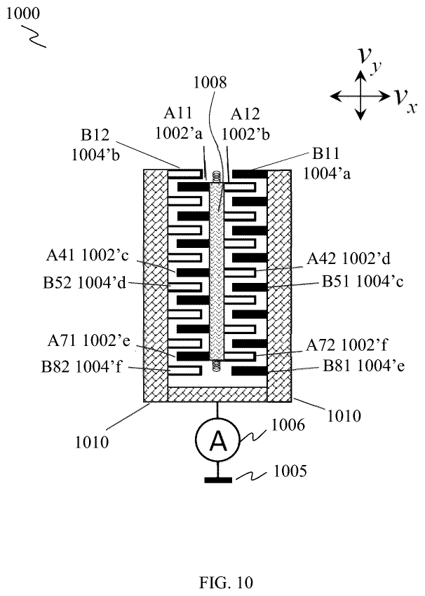

FIG. 10 shows a schematic view illustrating an exemplary arrangement where a sensor 1000 is used to monitor the vibration amplitude and frequency of a vibrational beam (the movable part) with respect to a stationary base or another movable object (the stationary part). The sensor 1000 may include the same or like elements or components as those of the sensor 100 of FIG. 2, and as such, the same ending numerals are assigned and the like elements may be as described in the context of the sensor 100 of FIG. 2, and therefore some corresponding descriptions may be omitted here. In the exemplary arrangement of FIG. 10, Electrodes A11 1002′a, . . . A41 1002′c, . . . A71 1002′e, A12 1002′b, . . . A42 1002′d, . . . A72 1002′f of the primary sensing part may be attached to a vibrational beam (the movable object) 1008 and Electrodes B11 1004′a, . . . B51 1004′c, . . . B81 1004′e, B12 1004′b, . . . B52 1004′d, . . . B82 1004′f of the secondary sensing part may be fixed to the stationary part (or another movable part) 1010. Electrodes A11 1002′a, . . . A41 1002′c, . . . A71 1002′e may include the same materials or different materials. Electrodes A12 1002′b, . . . A42 1002′d, . . . A72 1002′f may include the same materials or different materials. The materials involved in Electrodes Electrodes A11 1002′a, . . . A41 1002′c, . . . A71 1002′e may be different from the materials involved in Electrodes A12 1002′b, . . . A42 1002′d, . . . A72 1002′f. Electrodes B11 1004′a, . . . B51 1004′c, . . . B81 1004′e may include the same materials or different materials. Electrodes B12 1004′b, . . . B52 1004′d, . . . B82 1004′f may include the same materials or different materials. The materials involved in Electrodes B11 1004′a, . . . B51 1004′c, . . . B81 1004′e may be the same as or different from the materials involved in Electrodes B12 1004′b, . . . B52 1004′d, . . . B82 1004′f. In a specific exemplary arrangement, Electrodes A11 1002′a, . . . A41 1002′c, . . . A71 1002′e and B11 1004′a, . . . B51 1004′c, . . . B81 1004′e may include the same metallic/semiconducting material with a lower work function. Electrodes A12 1002′b, . . . A42 1002′d, . . . A72 1002′f and B12 1004′b, . . . B52 1004′d, . . . B82 1004′f may include another same metallic/semiconducting material with a higher work function. In another specific exemplary arrangement, Electrodes A11 1002′a, . . . A41 1002′c, . . . A71 1002′e may include the same metallic/semiconducting material with a lower work function. Electrodes A12 1002′b, . . . A42 1002′d, . . . A72 1002′f may include another same metallic/semiconducting material with a higher work function. Electrodes B11 1004′a, . . . B51 1004′c, . . . B81 1004′e and Electrodes B12 1004′b, . . . B52 1004′d, . . . B82 1004′f may include the same metallic/semiconducting material with a third work function, which may be the same as the lower work function material, or the same as the higher work function material or neither the lower nor the higher work function material. Electrodes A11 1002′a, . . . A41 1002′c, . . . A71 1002′e may be electrically coupled to Electrodes A12 1002′b, . . . A42 1002′d, . . . A72 1002′f. Electrodes B11 1004′a, . . . B51 1004′c, . . . B81 1004′e may be electrically coupled to Electrodes B12 1004′b, . . . B52 1004′d, . . . B82 1004′f. The electrodes of the primary sensing part and the electrodes of the secondary sensing part may be arranged with respect to another in a comb manner. An electrical signal is generated in between the stationary sensing part and a ground 1005 if the primary sensing part vibrates with respect to the stationary sensing part. The generated electrical signal may be measured by the electrical measurement unit 1006 coupled between the ground 1006 and the common electrical connection of Electrodes B11 1004′a, . . . B51 1004′c, . . . B81 1004′e and Electrodes B12 1004′b, . . . B52 1004′d, . . . B82 1004′f and may provide the information of the vibration speeds and amplitudes in the x axis direction (denoted by vₓ) and in the y axis direction (denoted by v_{y}) of the vibrational beam with respect to the stationary part 1010 or another movable object 1010.

While the method described above is illustrated and described as a series of steps or events, it will be appreciated that any ordering of such steps or events are not to be interpreted in a limiting sense. For example, some steps may occur in different orders and/or concurrently with other steps or events apart from those illustrated and/or described herein. In addition, not all illustrated steps may be required to implement one or more aspects or embodiments described herein. Also, one or more of the steps depicted herein may be carried out in one or more separate acts and/or phases.

It should also be appreciated and understood that exemplary arrangements described herein are not exhaustive, and other arrangements and configurations may also be possible. Challenging on-site sensing of relative reciprocating motions between two objects, including but not limited to detection of relative reciprocating motion velocity, vibration amplitude and frequency, the transient gap width between them, the eccentricity, the rotational speed and direction of a rotor, and so on, may be generally solved or circumvented. Several advances over the state-of-the-art are made by the sensing systems (e.g. the sensor 100 of FIGS. 1 and 2) and methods (e.g. the method 850 of FIG. 8) provided by various embodiments described herein. First, detection of relative motions between two objects, including, but not limited to detection of relative reciprocating motion velocity, vibration amplitude and frequency, the transient gap width between them, the eccentricity, rotational speed and direction of a rotor, amongst on-site in real-time. Second, the sensing system and method may produce electrostatic induction currents or voltages (electrical signals) by the difference in the polarities of the charges on the surfaces of the electrodes in the primary and secondary sensing parts through different work functions, or different ferroelectric properties, or different electret properties, or different pyroelectric properties of the electrode materials. Hence, the sensor may be self-powered, without using external power. Third, there is no wire connection or electric connection between the primary sensing part (movable object) and the secondary sensing part (stationary object or another movable object). Fourth, the sensor system and method making use of metals and/or semiconductor materials and/or ferroelectric materials and/or electrets, and/or pyroelectric materials may be easily integrated into other electronic devices, including integrated circuit (IC) chips. Fifth, the sensor may be employed as an energy harvester to convert the mechanical power of the movable object into electric power.

Various experimental findings in relation to the sensor (e.g. 100 of FIGS. 1 and 2) and method (e.g. 850 of FIG. 8) will be described below.

### Experimental Findings

In the following experiments, aluminium plates (about 20 mm×about 20 mm×about 1 mm) with a work function of about 4.28 eV is used as one type of the electrodes. Stainless steel plates (about 20 mm×about 20 mm×about 0.2 mm) with a work function of about 4.4 e V is used as another type of the electrodes. The primary sensing part attached to a movable object has one aluminium electrode and one stainless steel electrode. The two electrodes are connected together electrically. The stationary sensing part has one aluminium electrode and one stainless steel electrode. The two electrodes are connected together and then connected to a ground through an ammeter which may be described in similar context to the electrical measurement unit 106 of FIGS. 1 and 2.

### Part 1. Detections of Relative Rectilinear Motions

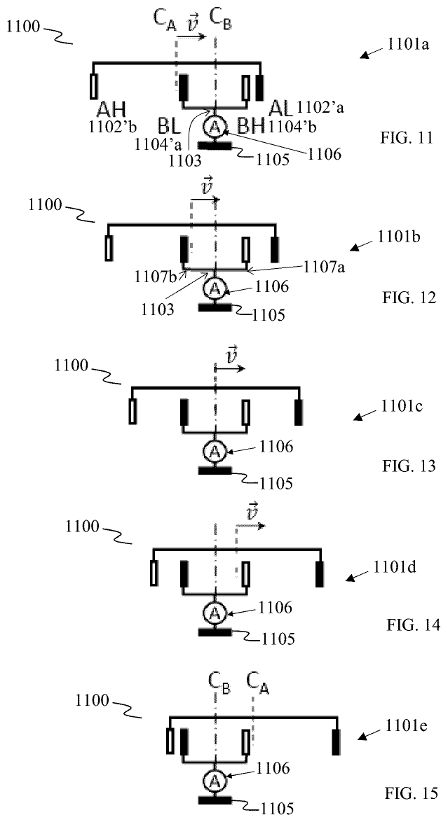

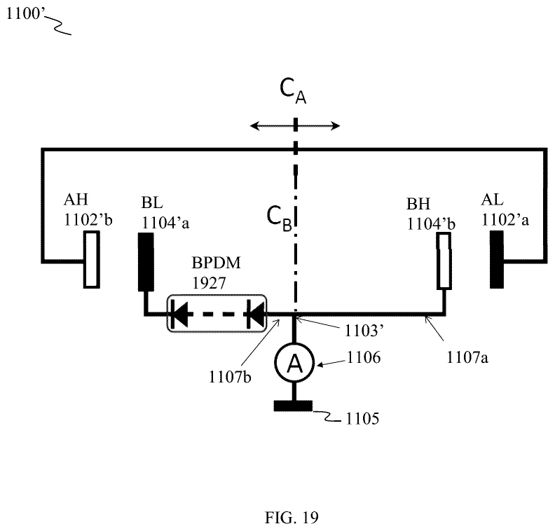

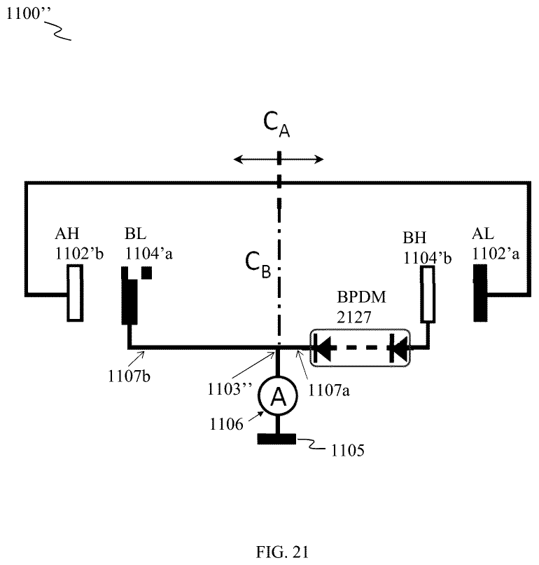

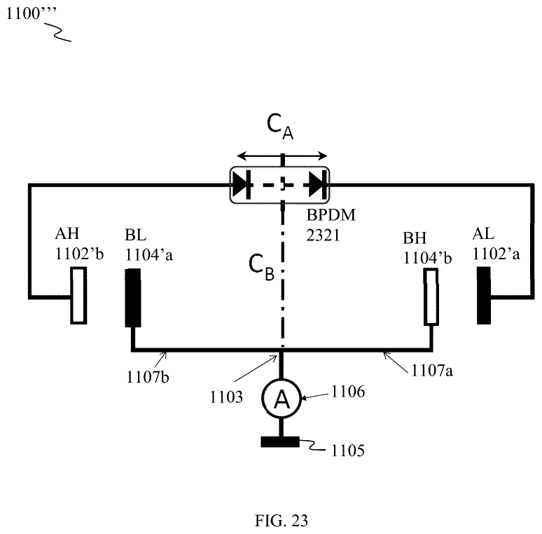

FIGS. 11, 12, 13, 14 and 15 show schematic views illustrating a series/sequence of stills (1101a, 1101b, 1101c, 1101d, 1101d, 1101e) involving relative rectilinear motions between the primary and secondary sensing parts of a sensor 1100, according to one example. FIG. 19 shows a schematic view of a sensor 1100′ with a BPDM 1927 being incorporated or coupled to Electrode BL 1104′a, according to another example. FIG. 21 shows a schematic view of a sensor 1100″ with a BPDM 2127 being incorporated or coupled to Electrode BH 1104′b, according to yet another example. FIG. 23 shows a schematic view of a sensor 1100″′ with a BPDM 2321 being incorporated or coupled between Electrodes AH 1102′b and AL 1102′a, according to a further example. Each of the sensors 1100, 1100′, 1100″, 1100″′ may be described in similar context to the sensor 100 of FIG. 2 and/or the sensor 300 of FIG. 3, and thus similar descriptions of the sensor 100 of FIG. 2 and/or the sensor 300 of FIG. 3 apply to each of the sensors 1100, 1100′, 1100″, 1100″′. For example, each of the sensors 1100, 1100′, 1100″, 1100″′ may have Electrodes BL 1104′a and BH 1104′b arranged in between the primary sensing part. In other examples (not shown in FIGS. 11 to 15, 19, 21 and 23), the primary sensing part may be arranged in between the secondary sensing part.

In relative rectilinear motions between the primary and secondary sensing parts, a geometrical centre, C_{B}, of the secondary (stationary) electrode pair may be taken as the reference. Thus, the displacement x of the two electrodes of the primary sensing part may be defined as the geometrical centre, C_{A}, of the two electrodes of the primary sensing part with respect to C_{B}. The eccentricity δ is defined as the centre of the motion range of C_{A} with respect to C_{B}. Electrodes AL 1102′a and BL 1104′a (in black) in FIGS. 11 to 15, 19, 21 and 23 are the aluminium electrodes with the dimensions of about 20 mm×about 20 mm×about 1 mm. Electrodes AH 1102′b and BH 1104′b (in white) in FIGS. 11 to 15, 19, 21 and 23 are the stainless steel electrodes with the dimensions of about 20 mm×about 20 mm×about 0.2 mm. An electrical measurement unit, e.g. an ammeter 1106 may be coupled between the connection of Electrodes BL 1104′a and BH 1104′b and a ground 1105. For example, with reference to FIGS. 11 to 15, and FIG. 23, the connection may be a common electrical connecting point 1103 formed by one end of a wire 1107a having the other end (of the wire 1107a) being electrically coupled to Electrode BH 1104′b, one end of the wire 1107b having the other end (of the wire 1107b) being electrically coupled to Electrode BL 1104′a, and one terminal (e.g. the positive terminal) of the electrical measurement unit 1106 with the other terminal (e.g. the negative terminal) electrically coupled to the ground 1105. Meanwhile in FIG. 19, the connection may be considered a common electrical connecting point 1103′ formed by one end of a wire 1107a having the other end (of the wire 1107a) being electrically coupled to Electrode BH 1104′b, one end of the wire 1107b having the other end (of the wire 1107b) being electrically coupled to Electrode BL 1104′a via BPDM 1927 arranged in series, and one terminal (e.g. the positive terminal) of the electrical measurement unit 1106 with the other terminal (e.g. the negative terminal) electrically coupled to the ground 1105. In FIG. 21, the connection may be considered a common electrical connecting point 1103″ formed by one end of a wire 1107a having the other end (of the wire 1107a) being electrically coupled to Electrode BH 1104′b via BPDM 2127 arranged in series, one end of the wire 1107b having the other end (of the wire 1107b) being electrically coupled to Electrode BL 1104′a, and one terminal (e.g. the positive terminal) of the electrical measurement unit 1106 with the other terminal (e.g. the negative terminal) electrically coupled to the ground 1105. The distance between Electrodes AL 1102′a and AH 1102′b may be fixed at about 62 mm and the distance between Electrodes BL 1104′a and BH 1104′b may be fixed at about 51 mm. Electrodes AL 1102′a and AH 1102′b are aligned with Electrodes BL 1104′a and BH 1104′b so that Electrode AL 1102′a is facing to Electrode BH 1104′b and Electrode AH 1102′b to Electrode BL 1104′a.

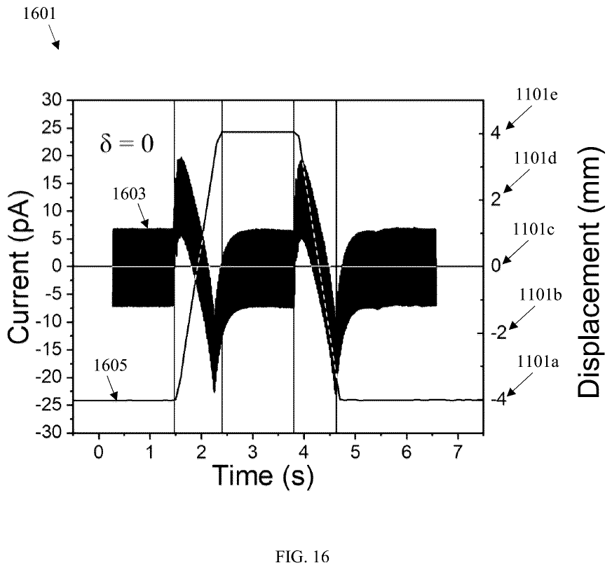

FIGS. 11 to 15 illustrate five relative positions of Electrodes AL 1102′a and AH 1102′b of the primary (movable) sensing part with respect to Electrodes BL 1104′a and BH 1104′b of the secondary (stationary) sensing part. Electrodes AL 1102′a and AH 1102′b move back and forth with respect to Electrodes BL 1104′a and BH 1104′b under a speed of about 10 mm/s with a motion range of 8.0 mm. In each motion cycle, the relative motion begins with Electrodes AL 1102′a and AH 1102′b moving rightward with respect to Electrodes BL 1104′a and BH 1104′b. Alternatively, it begins with the negative maximum displacements of −4.0 mm (FIG. 11), through 0 mm (FIG. 13), up to the positive maxium displacements of +4.0 mm (FIG. 15). After Electrodes AL 1102′a and AH 1102′b stay at rest for about 1500 ms, they move leftward with respect to Electrodes BL 1104′a and BH 1104′b till the negative maximum displacements of −4.0 mm. The minimum gaps between Electrodes AL 1102′a and BH 1104′b and between Electrodes AH 1102′b and BL 1104′a are about 3 mm. These relative motions create an eccentricity of δ=0 in this case. The current 1603 measured by the ammeter 1106 and the corresponding displacement x 1605 are shown in a graph 1601 of FIG. 16, where 1101a, 1101b, 1101c, 1101d, 1101c represent the five displacements and the corresponding relative positions of the two electrode pairs (i.e. Electrodes AL 1102′a, AH 1102′b, BL 1104′a and BH 1104′b) depicted in FIGS. 11 to 15, respectively. A rightward motion under a speed of about 10 mm/s creates a positive transient current with a peak value of about 12 pA for the displacement increasing from −4.0 mm up to 0 mm and a negative transient current with a peak value of about −12 pA for the displacement increasing from 0 mm up to +4.0 mm. A leftward motion under a speed of about 10 mm/s also creates a positive transient current with a peak value of about 12 pA for the dispalcement increasing from +4.0 mm down to 0 mm and a negative transient current with a peak value of about −12 pA for the displacement increasing from 0 mm down to −4.0 mm. In a full motion cycle, two identical transient current signals are generated under the condition of δ=0. Alternatively, the peak current difference A between the first positive peak and the second positive peak is zero, Δ=0 pA.

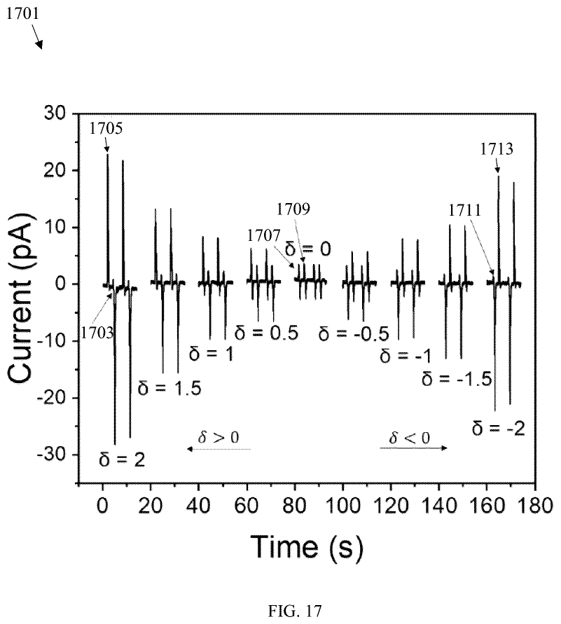

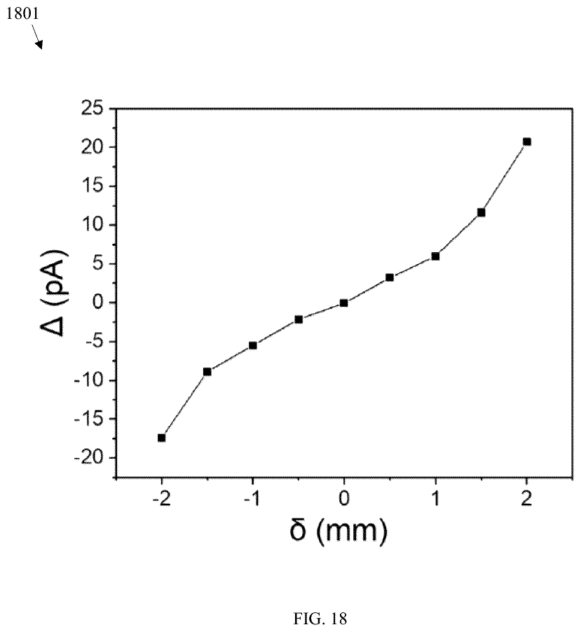

FIG. 17 shows a graph 1701 illustrating the transient currents created by relative motions between Electrodes AL 1102′a and AH 1102′b with respect to Electrodes BL 1104′a and BH 1104′b under several different eccentricities from δ=−2.0 mm to +2.0 mm. Except for the eccentricity, the set-ups of the primary and secondary sensing parts, the motional range of the primary sensing part and the relative speeds maintain the same as those for FIGS. 11 to 15 correspondingly. Interestingly, when δ is increased positively, the first positive current peak is increased and the second is decreased. At δ=+2.0 mm, the first positive current peak 1705 is nearly a factor of 7 larger than that (1707) under δ=0. In contrast, the second positive current peak 1703 is nearly zero. When δ is increased negatively, the first positive current peak is decreased and the second is increased. At δ=−2.0 mm, the first positive current peak 1711 is nearly zero, while the second positive current peak 1713 is nearly a factor of 6 larger than that (1709) under δ=0. As shown in a graph 1801 of FIG. 18 illustrating the peak current difference between the first positive current peak and the second positive current peak in one motion cycle shown in FIG. 17 as a function the eccentricity, the difference between the first and second positive current values, Δ, increases from −17 pA under δ=−2.0 mm to 23 pA under δ=+2.0 mm. Clearly, the transient current waveform strongly depends on the eccentricity δ. In other words, the transient current signals contain the information of the relative motions, including the eccentricity, vibration frequency, gap width, and so on.

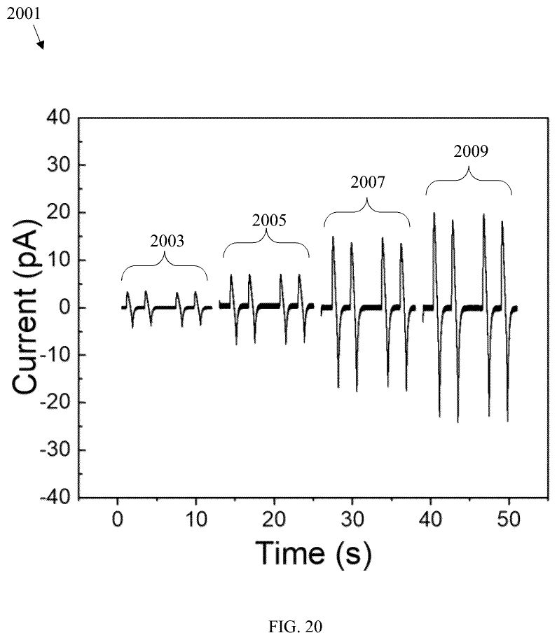

FIG. 19 shows a schematic view of a sensor 1100′ with the BPDM 1927 coupled or incorporated to Electrode BL 1104′a, according to one example, for the signal enhancement effect of BPDMs on the transient currents. The set-ups of the primary and secondary sensing parts, the motional range of the primary sensing part and the relative speeds maintain the same as those for FIGS. 11 to 15 under δ=0. The BPDM 1927, according to various examples, may be constructed purely from one diode or two or three diodes (e.g. 1N4001) in series connection. FIG. 20 shows a graph 2001 illustrating the transient currents acquired by the ammeter 1106 coupled to the ground 1105 and Electrodes BL 1104′a and BH 1104′b for the sensor 1100 (FIGS. 11 to 15) with no enhancement effect of BPDM (i.e. 0 diode) 2003, and for the sensor 1100′ (FIG. 19) with enhancement effect of BPDM 1927 having one diode 2005, two diodes 2007 and three diodes 2009.

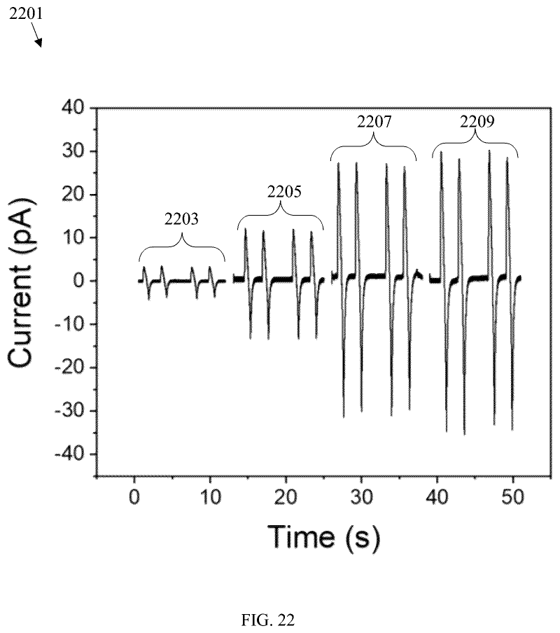

FIG. 21 shows a schematic view of a sensor 1100″ with the BPDM 2127 coupled or incorporated to Electrode BH 1104′b, according to one example, for the signal enhancement effect of BPDMs on the transient currents. The set-ups of the primary and secondary sensing parts, the motional range of the primary sensing part and the relative speeds maintain the same as those for FIGS. 11 to 15 under δ=0. The BPDM 2127, according to various examples, may be constructed purely from one diode or two or three diodes (e.g. 1N4001) in series connection. FIG. 22 shows a graph 2201 illustrating the transient currents acquired by the ammeter 1106 coupled to the ground 1105 and Electrodes BL 1104′a and BH 1104′b for the sensor 1100 (FIGS. 11 to 15) with no enhancement effect of BPDM (i.e. 0 diode) 2203, and for the sensor 1100″ (FIG. 21) with enhancement effect of BPDM 2127 having one diode 2205, two diodes 2207 and three diodes 2209.

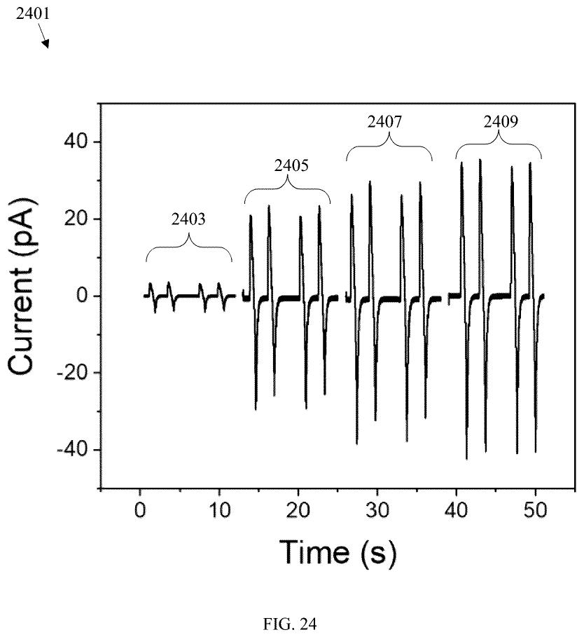

FIG. 23 shows a schematic view of a sensor 1100″′ with the BPDM 2321 coupled or incorporated between Electrodes AH 1102′b and AL 1102′a, according to one example, for the signal enhancement effect of BPDMs on the transient currents. The set-ups of the primary and secondary sensing parts, the motional range of the primary sensing part and the relative speeds maintain the same as those for FIGS. 11 to 15 under δ=0. The BPDM 2321, according to various examples, may be constructed purely from one diode or two or three diodes (e.g. 1N4001) in series connection. FIG. 24 shows a graph 2401 illustrating the transient currents acquired by the ammeter 1106 coupled to the ground 1105 and Electrodes BL 1104′a and BH 1104′b for the sensor 1100 (FIGS. 11 to 15) with no enhancement effect of BPDM (i.e. 0 diode) 2403, and the sensor 1100″′ (FIG. 23) with enhancement effect of BPDM 2321 having one diode 2405, two diodes 2407 and three diodes 2409.

The current enhancement effect may be evident from FIGS. 20, 22 and 24 in that the current enhancement becomes more significant with increasing number of the diodes.

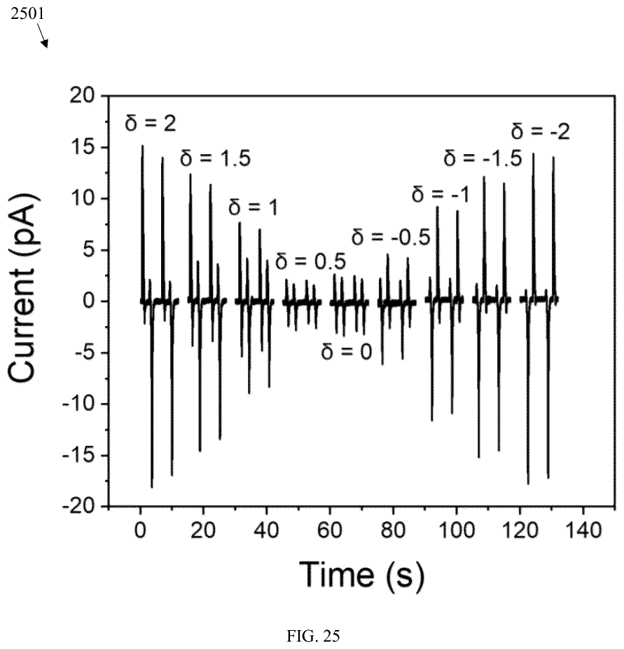

FIG. 25 shows a graph 2501 illustrating the transient current signals due to the relative motion of Electrodes AL 1102′a and AH 1102′b with respect to Electrodes BL 1104′a and BH 1104′b where Electrodes BL 1104′a and BH 1104′b have the same electrode material, the stainless steel plate with the dimensions of about 20 mm×about 20 mm×about 0.2 mm, according to one example. Except for Electrodes BL 1104′a being identical to Electrode BH 1104′b, the set-ups of the primary and secondary sensing parts, the motional range of the primary sensing part and the relative speeds maintain the same as those for FIG. 17. Under δ=0, Δ=0 is observed in a full relative motion cycle. With increasing δ positively and negatively, Δ shows a clear function of δ, in a similar manner or trend as displayed in FIG. 17.

### Part II. Detections of Relative Rotational Motions

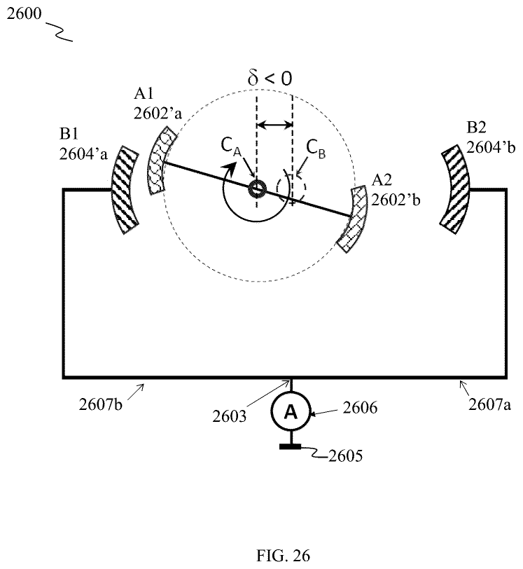

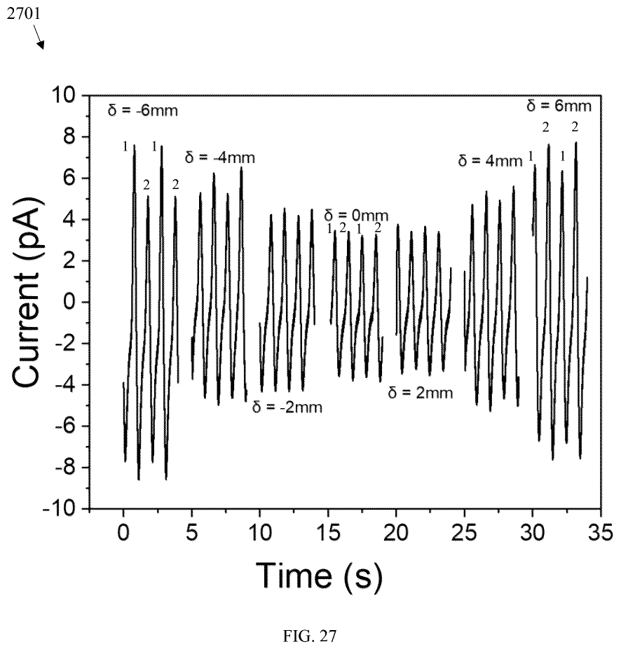

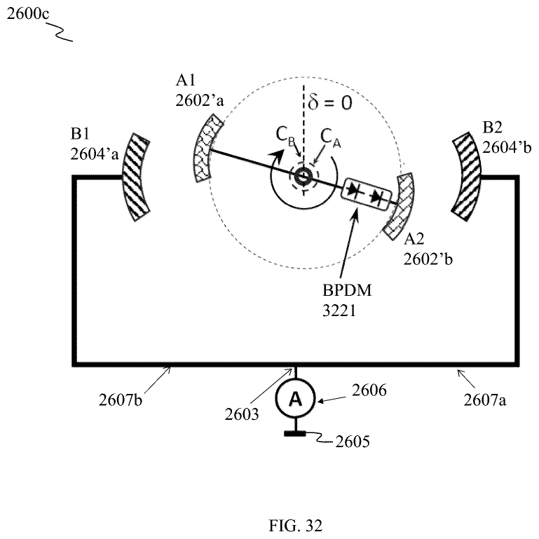

FIG. 26 shows a schematic view illustrating the sensor 2600 with Electrodes A1 2602′a and A2 2602′b installed to a rotor (not shown in FIG. 26) and Electrodes B1 2604′a and B2 2604′b installed to a stator (not shown in FIG. 26). An ammeter 2606 may be introduced in between the connection of Electrodes B1 2604′a and B2 2604′b and the ground 2605. In FIG. 26 (as well as FIGS. 32, 34, 36 and 38 that will be described later on), the connection is a common electrical connecting point 2603 formed by one end of the wire 2607a having the other end (of the wire 2607a) being electrically coupled to Electrode B2 2604′b, one end of the wire 2607b having the other end (of the wire 2607b) being electrically coupled to Electrode B1 2604′a, and one terminal (e.g. the positive terminal) of the ammeter 2606 with the other terminal (e.g. the negative terminal) electrically coupled to the ground 2605. The sensor 2600 may include the same or like elements or components as those of the sensor 100 of FIG. 2, and as such, similar ending numerals are assigned and the like elements may be as described in the context of the sensor 100 of FIG. 2, and therefore some corresponding descriptions may be omitted here. Stainless steel plates with the dimensions of about 20 mm×about 20 mm×about 0.2 mm are used as Electrodes A1 2602′a and B1 2604′a, and aluminium plates with the dimensions of about 20 mm×about 20 mm×about 1 mm are used as Electrodes A2 2602′b and B2 2604′b. The distance between Electrodes B1 2604′a and B2 2604′b may be fixed at about 68 mm and the distance between Electrodes A1 2602′a and A2 2602′b may be fixed at about 48 mm. Points C_{A} and C_{B} stand for the rotational centre for the rotor and the geometric centre for the stator, respectively. The eccentricity δ is defined as the distance between Points C_{B} and C_{A} and δ<0 in FIG. 26. An ammeter 2606 is coupled between the joint connection of Electrodes B1 2604′a and B2 2604′b and the ground 2605, according to one example. The eccentricity δ is defined as the distance between the centre of the rotor and the centre of the stator. A transient current may be generated once the rotor rotates with respect to the stator and it may be measured with the ammeter 2606. In each rotation cycle, two transient current signals may be created. In FIG. 27, Peak “1” is generated when Electrode A1 2602′a (Electrode A2 2602′b) is facing and passing near Electrode B2 2604′b (Electrode B1 2604′a), while Peak “2” is generated when Electrode A1 2602′a (Electrode A2 2602′b) is facing and passing near Electrode B1 2604′a (Electrode B2 2604′b). For δ=0, the two current signals, based on Peak “1” and Peak “2”, look identical, as shown in a graph 2701 of FIG. 27. However, when δ≠0, the difference between the two current signals becomes apparent and the peak-to-peak current increases with increasing δ.

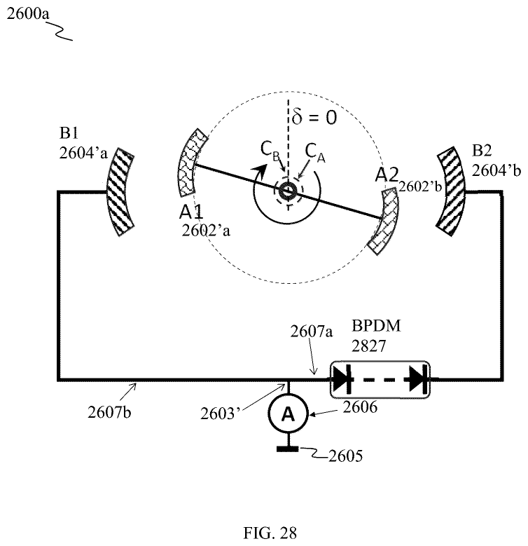

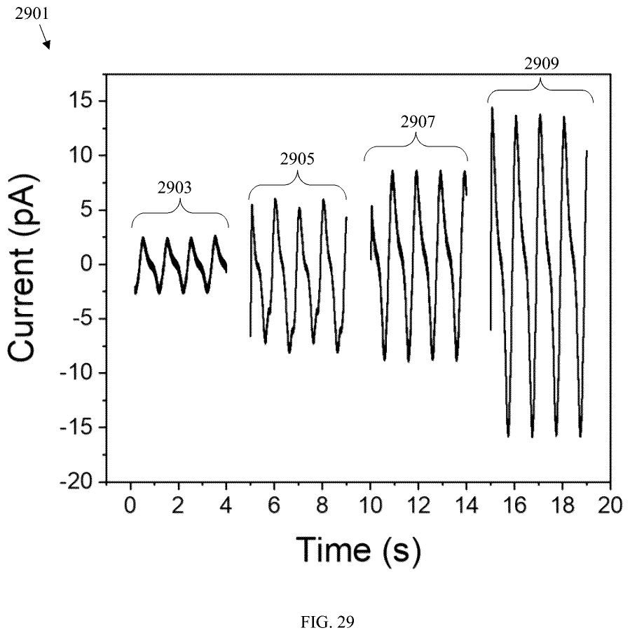

FIG. 28 shows a schematic view of a sensor 2600a with the BPDM 2827 coupled or incorporated to Electrode B2 2604′b, according to one example, for the signal enhancement effect of BPDMs on the transient currents due to rotation of Electrodes A1 2602′a and A2 2602′b with respect to Electrodes B1 2604′a and B2 2604′b under δ=0. The electrodes involved and the rotation between the two electrode pairs are the same as those described in FIG. 26. In FIG. 28, a common electrical connecting point 2603′ may be formed by one end of the wire 2607a having the other end (of the wire 2607a) being electrically coupled to Electrode B2 2604′b via BPDM 2827 arranged in series, one end of the wire 2607b having the other end (of the wire 2607b) being electrically coupled to Electrode B1 2604′a, and one terminal (e.g. the positive terminal) of the ammeter 2606 with the other terminal (e.g. the negative terminal) electrically coupled to the ground 2605. The sensor 2600a may include the same or like elements or components as those of the sensor 100 of FIG. 2, and as such, similar ending numerals are assigned and the like elements may be as described in the context of the sensor 100 of FIG. 2, and therefore some corresponding descriptions may be omitted here. The BPDM 2827, according to various examples, may be constructed purely from one diode or two or three diodes (e.g. 1N4001) in series connection. FIG. 29 shows a graph 2901 illustrating the transient currents acquired by the ammeter 2606 coupled to the ground 2605 and Electrodes B1 2604′a and B2 2604′b for the sensor 2600 (FIG. 26) with no enhancement effect of BPDM (i.e. 0 diode) 2903, and for the sensor 2600a with enhancement effect of BPDM 2827 having one diode 2905, two diodes 2907 and three diodes 2909.

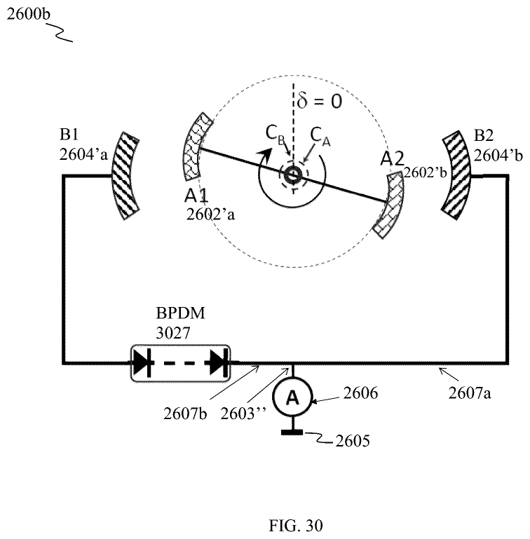

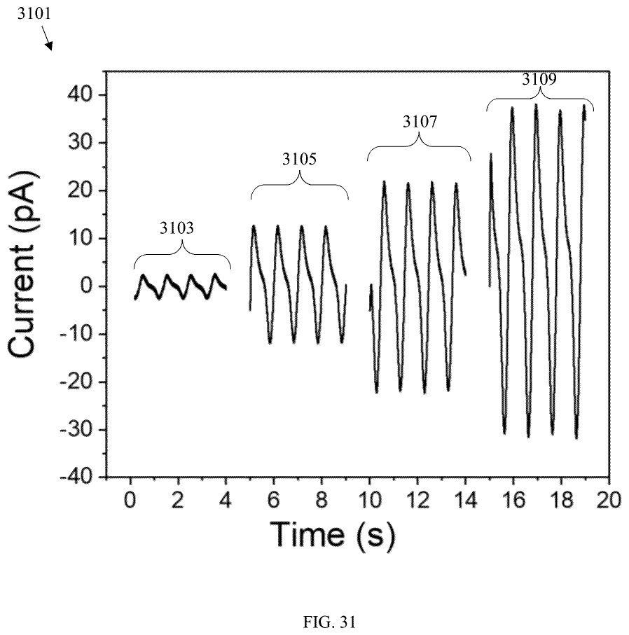

FIG. 30 shows a schematic view of a sensor 2600b with the BPDM 3027 coupled or incorporated to Electrode B1 2604′a, according to one example, for the signal enhancement effect of BPDMs on the transient currents due to rotation of Electrodes A1 2602′a and A2 2602′b with respect to Electrodes B1 2604′a and B2 2604′b under δ=0. The electrodes involved and the rotation between the two electrode pairs are the same as those described in FIG. 26. In FIG. 30, a common electrical connecting point 2603″ may be formed by one end of the wire 2607a having the other end (of the wire 2607a) being electrically coupled to Electrode B2 2604′b, one end of the wire 2607b having the other end (of the wire 2607b) being electrically coupled to Electrode B1 2604′a via BPDM 3027 arranged in series, and one terminal (e.g. the positive terminal) of the ammeter 2606 with the other terminal (e.g. the negative terminal) electrically coupled to the ground 2605. The sensor 2600b may include the same or like elements or components as those of the sensor 100 of FIG. 2, and as such, similar ending numerals are assigned and the like elements may be as described in the context of the sensor 100 of FIG. 2, and therefore some corresponding descriptions may be omitted here. The BPDM 3027, according to various examples, may be constructed purely from one diode or two or three diodes (e.g. 1N4001) in series connection. FIG. 31 shows a graph 3101 illustrating the transient currents acquired by the ammeter 2606 coupled to the ground 2605 and Electrodes B1 2604′a and B2 2604′b for the sensor 2600 (FIG. 26) with no enhancement effect of BPDM (i.e. 0 diode) 3103, and for the sensor 2600b (FIG. 30) with enhancement effect of BPDM 3027 having one diode 3105, two diodes 3107 and three diodes 3109.

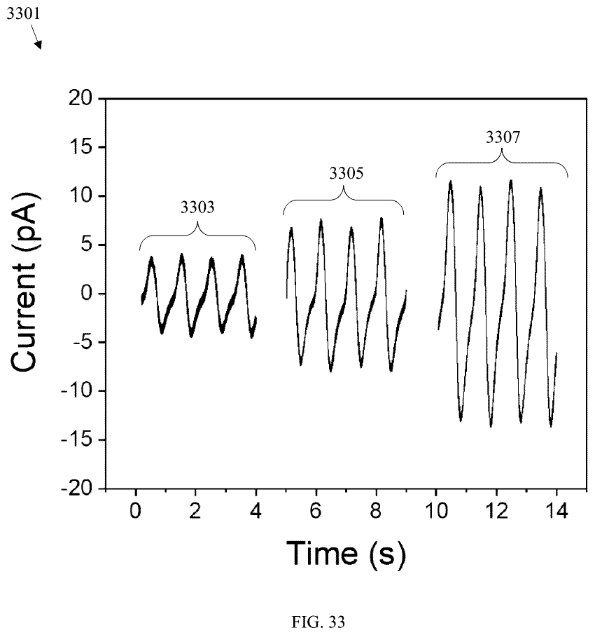

FIG. 32 shows a schematic view of a sensor 2600c with the BPDM 3221 coupled or incorporated to Electrode A2 2602′b, according to one example, for the signal enhancement effect of BPDMs on the transient currents due to rotation of Electrodes A1 2602′a and A2 2602′b with respect to Electrodes B1 2604′a and B2 2604′b under δ=0. The electrodes involved and the rotation between the two electrode pairs are the same as those described in FIG. 26. The sensor 2600c may include the same or like elements or components as those of the sensor 100 of FIG. 2, and as such, similar ending numerals are assigned and the like elements may be as described in the context of the sensor 100 of FIG. 2, and therefore some corresponding descriptions may be omitted here. The BPDM 3221, according to various examples, may be constructed purely from one diode or two diodes (e.g. 1N4001) in series connection. FIG. 33 shows a graph 3301 illustrating the transient currents acquired by the ammeter 2606 coupled to the ground 2605 and Electrodes B1 2604′a and B2 2604′b for the sensor 2600 (FIG. 26) with no enhancement effect of BPDM (i.e. 0 diode) 3303, and for the sensor 2600c (FIG. 32) with enhancement effect of BPDM 3221 having one diode 3305, and two diodes 3307.

The current (signal) enhancement effect may be evident from FIGS. 29, 31 and 33 in that the current enhancement becomes more significant with increasing number of the diodes.

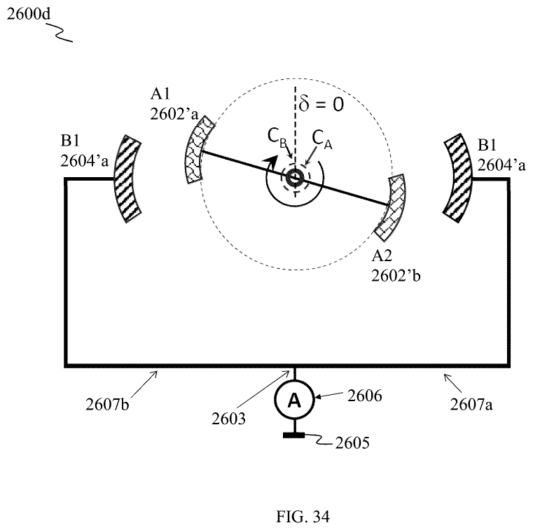

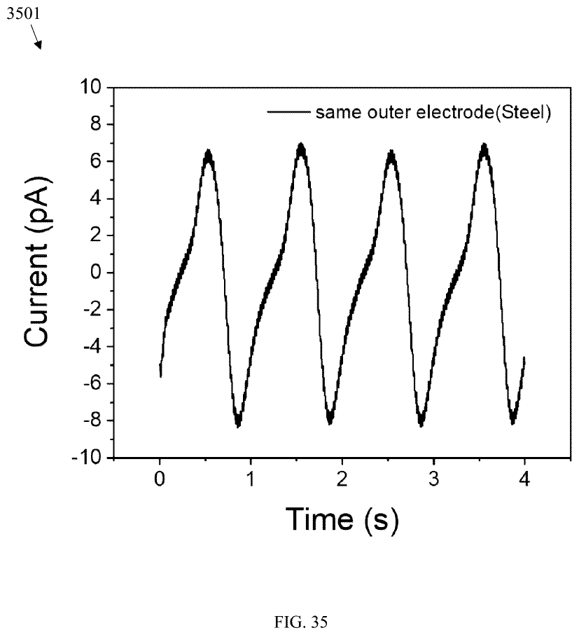

FIG. 34 shows a schematic view illustrating the sensor 2600d with Electrodes A1 2602′a and A2 2602′b installed to a rotor and two Electrodes B1 2604′a installed to a stator under δ=0. Essentially, the sensor 2600d is similar to the sensor 2600 of FIG. 26, except that Electrodes B1 2604′a and B2 2604′b (of the sensor 2600) now have the same electrode material as shown by two Electrodes B1 2604′a in FIG. 34. The same material may be the stainless steel plate with the dimensions of about 20 mm×about 20 mm×about 0.2 mm, according to one example. The set-up of the primary sensing part, the rotation speed of the primary sensing part maintain the same as those for FIG. 26 under δ=0. The sensor 2600d may include the same or like elements or components as those of the sensor 100 of FIG. 2, and as such, similar ending numerals are assigned and the like elements may be as described in the context of the sensor 100 of FIG. 2, and therefore some corresponding descriptions may be omitted here. Once the rotor rotates with respect to the stator, transient current may be generated, as shown in a graph 3501 of FIG. 35. Two identical transient current signals may be created in each rotational cycle.

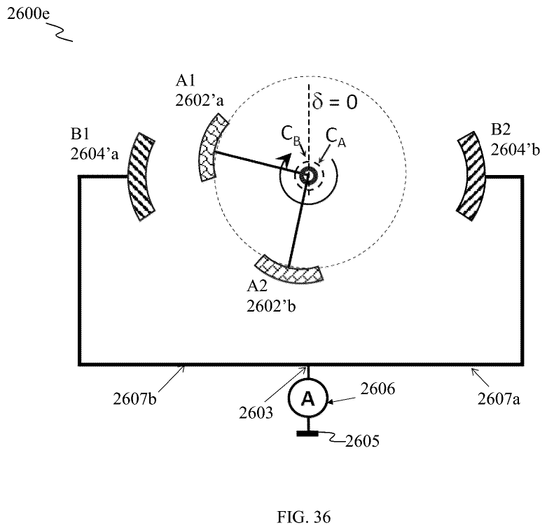

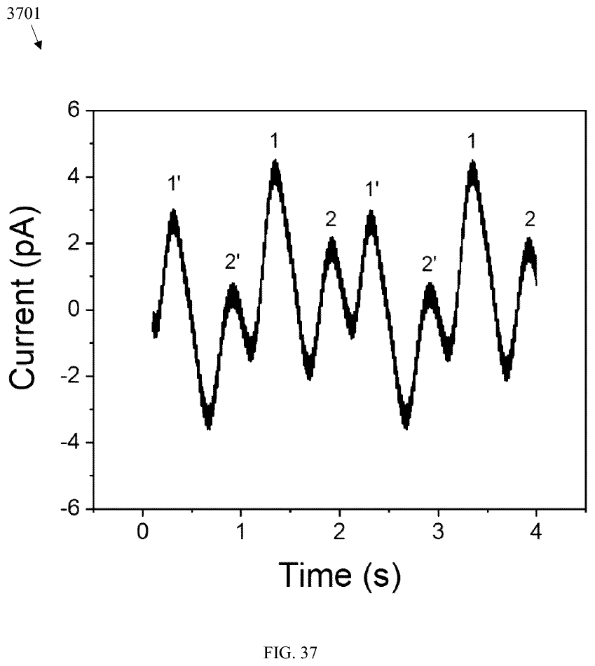

FIG. 36 shows a schematic view illustrating the sensor 2600e with Electrodes A1 2602′a and A2 2602′b installed to a rotor and Electrodes B1 2604′a and B2 2604′b installed to a stator under δ=0, where Electrodes A1 2602′a and A2 2602′b in the primary sensing part are attached to the rotor at the locations so that the smaller angle between the two virtual lines from the rotor centre to the two electrode centers is approximately 90°. It should be appreciated that in other examples not shown in the figures, it is possible to adopt different angles between the two virtual lines from the rotor centre to the two electrode centers, apart from 90° (as seen in FIGS. 36) and 180° (as seen in FIGS. 26, 28, 30, 32 and 34). In FIG. 36, except for the locations of Electrodes A1 2602′a and A2 2602′b, the set-up of the secondary sensing part, the rotation speed of the primary sensing part maintain the same as those for FIG. 26 under δ=0. The sensor 2600e may include the same or like clements or components as those of the sensor 100 of FIG. 2, and as such, similar ending numerals are assigned and the like elements may be as described in the context of the sensor 100 of FIG. 2, and therefore some corresponding descriptions may be omitted here. The transient currents acquired with the ammeter 2606 of FIG. 36 are shown in a graph 3701 of FIG. 37. Four transient current peaks (peaks shown as 1′, 2′, 1, 2) are generated in the cach rotation cycle.

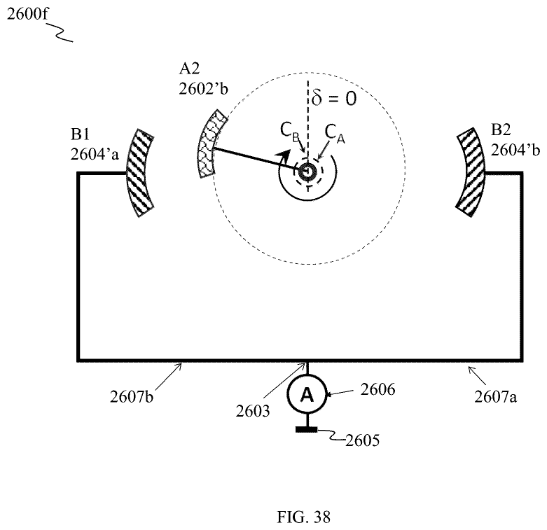

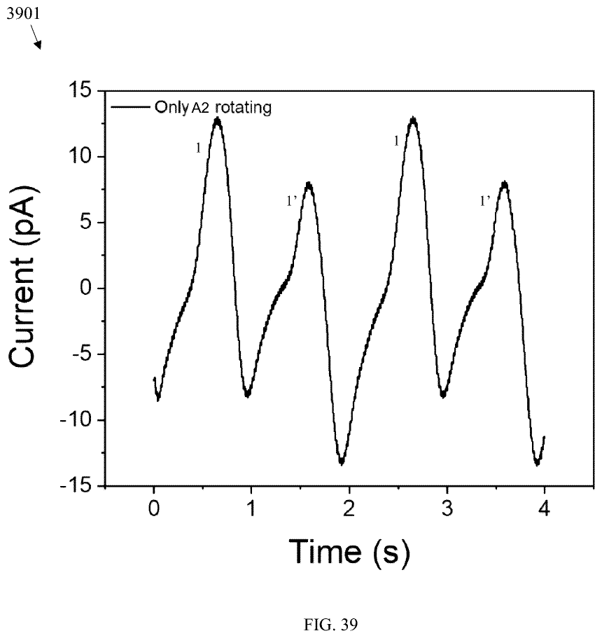

FIG. 38 shows a schematic view illustrating the sensor 2600f with only one electrode, i.e. Electrode A2 2602′b (the aluminum electrode), in the primary sensing part installed to a rotor and Electrodes B1 2604′a and B2 2604′b installed to a stator under δ=0. A piece of stainless steel (not shown in FIG. 38), which is connected to Electrode A2 2602′b, is also attached to the rotor, but not facing to the two electrodes B1 2604′a and B2 2604′b of the secondary sensing part while rotating. Except for the only one Electrode A2 2602′b in the primary sensing part, the set-up of the secondary sensing part, the rotation speed of the primary sensing part maintain the same as those for FIG. 26. The sensor 2600cmay include the same or like elements or components as those of the sensor 100 of FIG. 2, and as such, similar ending numerals are assigned and the like elements may be as described in the context of the sensor 100 of FIG. 2, and therefore some corresponding descriptions may be omitted here. Transient current acquired with the ammeter 2606 of FIG. 38 is shown in a graph 3901 of FIG. 39. Two different current peaks (peaks shown as 1′, 1) are generated in each rotation cycle even under under δ=0.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A sensor comprising:
a primary sensing part comprising a single primary electrode or multiple primary electrodes,
wherein the single primary electrode comprises a first material and a second material electrically coupled to the first material, the first material being different from the second material,
wherein the multiple primary electrodes comprise two or more primary electrodes, at least some of the multiple primary electrodes comprising one primary electrode material or different primary electrode materials,
wherein the multiple primary electrodes are electrically coupled to one another to form a common electrical connection, or each of the multiple primary electrodes is electrically coupled to one or more of the multiple primary electrodes to form separate electrical connections;
a secondary sensing part comprising a single secondary electrode or multiple secondary electrodes,
wherein the single secondary electrode comprises a third material and a fourth material electrically coupled to the third material, the third material being different from the fourth material,
wherein the multiple secondary electrodes comprise two or more secondary electrodes, at least some of the multiple secondary electrodes comprising one secondary electrode material or different secondary electrode materials,
wherein the multiple secondary electrodes are electrically coupled to one another to form a common electrical connecting point, or each of the multiple secondary electrodes is electrically coupled to one or more of the multiple secondary electrodes to form separate electrical connecting points; and
one or more electrical measurement units each electrically coupled to:
the single primary electrode and a ground, or
one primary electrode of the multiple primary electrodes and another primary electrode of the multiple primary electrodes, or
the common electrical connection of the multiple primary electrodes and the ground, or
the separate electrical connections of the multiple primary electrodes and the ground, or
the single secondary electrode and the ground, or
one secondary electrode of the multiple secondary electrodes and another secondary electrode of the multiple secondary electrodes, or
the common electrical connecting point of the multiple secondary electrodes and the ground, or
the separate electrical connecting points of the multiple secondary electrodes and the ground,
wherein the primary sensing part and the secondary sensing part are free from electrical connection with each other;
wherein the single primary electrode or at least one of the multiple primary electrodes is configured to be attached to a movable object, and the single secondary electrode or at least one of the multiple secondary electrodes is configured to be fixed to a stationary object or another movable object;
wherein the primary sensing part is arranged to be spaced apart from the secondary sensing part within an electrostatic interaction range; and
wherein the single primary electrode or the at least one of the multiple primary electrodes and the single secondary electrode or the at least one of the multiple secondary electrodes are arranged to move relatively to each other to generate one or more electrical signals measurable by the one or more electrical measurement units, the generated one or more electrical signals being representative of at least one quantifiable parameter of relative motion between the primary sensing part and the secondary sensing part.

2. The sensor as claimed in claim 1, wherein the sensor is a self-powered sensor, or an externally powered sensor.

3. The sensor as claimed in claim 1, wherein the different primary electrode materials and the different secondary electrode materials have different work functions, or different ferroelectric properties, or different electret properties, or different pyroelectric properties.

4. The sensor as claimed in claim 1,
wherein the first material, the second material, the third material, the fourth material, the primary electrode material, or the secondary electrode material comprises one of the following:
a metal;
a semiconductor;
a ferroelectric material;
an electret; or
a pyroelectric material, and
wherein the different primary electrode materials, or the different secondary electrode materials comprise at least one of the following:
a metal;
a semiconductor;
a ferroelectric material;
an electret; or
a pyroelectric material.

5. The sensor as claimed in claim 1, wherein the one or more electrical measurement units, and the single primary electrode or the multiple primary electrodes are arranged in at least one of the following configurations:
the one or more electrical measurement units being electrically coupled:
between the ground and the single primary electrode; or
between the ground and the multiple primary electrodes at the common electrical connection; or
between the ground and at least some of the multiple primary electrodes at the respective separate electrical connections; or
between one or more of the multiple primary electrodes and another one or more of the multiple primary electrodes.

6. The sensor as claimed in claim 1, wherein the one or more electrical measurement units, and the single secondary electrode or the multiple secondary electrodes are arranged in at least one of the following configurations:
the one or more electrical measurement units being electrically coupled:
between the ground and the single secondary electrode; or
between the ground and the multiple secondary electrodes at the common electrical connecting point; or
between the ground and at least some of the multiple secondary electrodes at the respective separate electrical connecting points; or
between one or more of the multiple secondary electrodes and another one or more of the multiple secondary electrodes.

7. The sensor as claimed in claim 1, wherein
each of the one or more electrical measurement units is configured to condition or measure or both condition and measure the generated one or more electrical signals; and
each of the one or more electrical measurement units has either:
single-ended inputs comprising: an input and the ground, or
differential inputs comprising: a non-inverting input and an inverting input.

8. The sensor as claimed in claim 1, wherein the single primary electrode or the multiple primary electrodes each has a front surface coated with passivation layers, the front surface being a surface arranged to be respectively positioned facing to the single secondary electrode or each of the multiple secondary electrodes; and/or
wherein the single secondary electrode or the multiple secondary electrodes each has a frontal surface coated with passivation layers, the frontal surface being a surface arranged to be respectively positioned facing to the single primary electrode or each of the multiple primary electrodes.

9. The sensor as claimed in claim 1, further comprising one or more built-in potential difference multipliers,
wherein the one or more built-in potential difference multipliers is:
electrically coupled to the single primary electrode or the multiple primary electrodes; or
electrically coupled to the single secondary electrode or the multiple secondary electrodes.

10. The sensor as claimed in claim 9, wherein the one or more built-in potential difference multipliers comprises one of the following:
one or more components coupled in series, each component comprising:
a first portion including a metal, or a semiconductor, or a ferroelectric material, or a pyroelectric material, or a functionalized material; and
a second portion including another metal, or another semiconductor, or another ferroelectric material, or another pyroelectric material, or another functionalized material, wherein the second portion is adjacent to the first portion; or
one or more diodes coupled in series; or
one or more semiconductor junctions coupled in series; or
one or more energy storage devices coupled in series.

11. The sensor as claimed in claim 1, further comprising:
one or more tertiary sensing parts each comprising a single tertiary electrode or multiple tertiary electrodes,
wherein the single tertiary electrode comprises a fifth material and a sixth material electrically coupled to the fifth material, the fifth material being different from the sixth material,
wherein the multiple tertiary electrodes comprise two or more tertiary electrodes, at least some of the multiple tertiary electrodes comprising one tertiary electrode material or different tertiary electrode materials,
wherein the multiple tertiary electrodes are electrically coupled to one another to form a common electrical connecting node, or each of the multiple tertiary electrodes is electrically coupled to one or more of the multiple tertiary electrodes to form separate electrical connecting nodes,
wherein the single tertiary electrode or at least one of the multiple tertiary electrodes is configured to be fixed to the stationary object or the other movable object and is arranged spaced apart from the single secondary electrode or the at least one of the multiple secondary electrodes when fixed to the stationary object or the other movable object;
wherein the one or more electrical measurement units each is electrically coupled to:
the single tertiary electrode and the ground, or
one tertiary electrode of the multiple tertiary electrodes and another tertiary electrode of the multiple tertiary electrodes, or
the common electrical connecting node of the multiple tertiary electrodes and the ground, or
the separate electrical connecting nodes of the multiple tertiary electrodes and the ground;
wherein the primary sensing part is arranged to be spaced apart from the one or more tertiary sensing parts within the electrostatic interaction range; and
wherein the single primary electrode or the at least one of the multiple primary electrodes and the single tertiary electrode or the at least one of the multiple tertiary electrodes are arranged to move relatively to each other to generate one or more subsidiary electrical signals measurable by the one or more electrical measurement units.

12. The sensor as claimed in claim 11, wherein the single tertiary electrode or the multiple tertiary electrodes each has a fore surface coated with passivation layers, the fore surface being a surface arranged to be respectively positioned facing to the single primary electrode or each of the multiple primary electrodes.

13. The sensor as claimed in claim 11, further comprising one or more built-in potential difference multipliers,
wherein the one or more built-in potential difference multipliers is electrically coupled to the single tertiary electrode or the multiple tertiary electrodes.

14. A method for determining at least one quantifiable parameter of relative motion between a movable object and a stationary object or another movable object, the method comprising:
providing a sensor comprising:
a primary sensing part comprising a single primary electrode or multiple primary electrodes,
wherein the single primary electrode comprises a first material and a second material electrically coupled to the first material, the first material being different from the second material,
wherein the multiple primary electrodes comprise two or more primary electrodes, at least some of the multiple primary electrodes comprising one primary electrode material or different primary electrode materials,
wherein the multiple primary electrodes are electrically coupled to one another to form a common electrical connection, or each of the multiple primary electrodes is electrically coupled to one or more of the multiple primary electrodes to form separate electrical connections;
a secondary sensing part comprising a single secondary electrode or multiple secondary electrodes,
wherein the single secondary electrode comprises a third material and a fourth material electrically coupled to the third material, the third material being different from the fourth material,
wherein the multiple secondary electrodes comprise two or more electrodes, at least some of the multiple secondary electrodes comprising one secondary electrode material or different secondary electrode materials,
wherein the multiple secondary electrodes are electrically coupled to one another to form a common electrical connecting point, or each of the multiple secondary electrodes is electrically coupled to one or more of the multiple secondary electrodes to form separate electrical connecting points; and
one or more electrical measurement units each electrically coupled to:
the single primary electrode and a ground, or
one primary electrode of the multiple primary electrodes and another primary electrode of the multiple primary electrodes, or
the common electrical connection of the multiple primary electrodes and the ground, or
the separate electrical connections of the multiple primary electrodes and the ground, or
the single secondary electrode and the ground, or
one secondary electrode of the multiple secondary electrodes and another secondary electrode of the multiple secondary electrodes, or
the common electrical connecting point of the multiple secondary electrodes and the ground, or
the separate electrical connecting points of the multiple secondary electrodes and the ground,
wherein the primary sensing part and the secondary sensing part are free from electrical connection with each other;
attaching the single primary electrode or at least one of the multiple primary electrodes to the movable object;
attaching the single secondary electrode or at least one of the multiple secondary electrodes to the stationary object or the other movable object, with the single secondary electrode or the at least one of the multiple secondary electrodes positioned facing towards the single primary electrode or the at least one of the multiple primary electrodes such that the primary sensing part is spaced apart from the secondary sensing part within an electrostatic interaction range; and
measuring, by the one or more electrical measurement units, one or more electrical signals generated in the sensor, wherein the generated one or more electrical signals are representative of the at least one quantifiable parameter of relative motion between the primary sensing part and the secondary sensing part.

15. The method as claimed in claim 14,
wherein the movable object comprises a rotor of a motor or a bearing or a joint of two mechanical parts,
wherein the stationary object comprises a stator of the motor, or a holder of the bearing, or an arm connected to the joint; and
wherein measuring the one or more electrical signals comprises measuring the one or more electrical signals representative of at least one of a rotational speed or an eccentricity of the rotor or the bearing or the joint or gaps between the movable object and the stationary object.

16. The method as claimed in claim 15,
wherein the sensor further comprises:
one or more tertiary sensing parts each comprising a single tertiary electrode or multiple tertiary electrodes,
wherein the single tertiary electrode comprises a fifth material and a sixth material electrically coupled to the fifth material, the fifth material being different from the sixth material,
wherein the multiple tertiary electrodes comprise two or more electrodes, at least some of the multiple tertiary electrodes comprising one tertiary electrode material or different tertiary electrode materials,
wherein the multiple tertiary electrodes are electrically coupled to one another to form a common electrical connecting node, or each of the multiple tertiary electrodes is electrically coupled to one or more of the multiple tertiary electrodes to form separate electrical connecting nodes,
wherein the one or more electrical measurement units is each electrically coupled to:
the single tertiary electrode and a ground, or
one tertiary electrode of the multiple tertiary electrodes and another tertiary electrode of the multiple tertiary electrodes, the common electrical connecting node of the multiple tertiary electrodes and the ground, or
the separate electrical connecting nodes of the multiple tertiary electrodes and the ground, and
wherein the method further comprises:
attaching the single tertiary electrode or at least one of the multiple tertiary electrodes to the stationary object or the other movable object, with the single tertiary electrode or the at least one of the multiple tertiary electrodes positioned facing towards the single primary electrode or the at least one of the multiple primary electrodes such that the primary sensing part is spaced apart from the one or more tertiary sensing parts within the electrostatic interaction range, and the single tertiary electrode or the at least one of the multiple tertiary electrodes is arranged spaced apart from the single secondary electrode or the at least one of the multiple secondary electrodes when fixed to the stationary object or the other movable object;
measuring, by the one or more electrical measurement units, one or more subsidiary electrical signals generated in the single tertiary electrode or each of the multiple tertiary electrodes; and
determining the eccentricity of the rotor in two or more different directions based on the generated one or more subsidiary electrical signals and the generated one or more electrical signals.

17. The method as claimed in claim 14,
wherein the movable object comprises a vibrational beam or a reciprocating movable object,
wherein the stationary object comprises a base supporting the vibrational beam or a holder of the reciprocating movable object, and
wherein measuring the one or more electrical signals comprises measuring the one or more electrical signals representative of at least one of a position variation amplitude or a frequency of the vibrational beam or the reciprocating movable object with respect to the stationary object or the other movable object near the vibrational beam or the reciprocating movable object.

18. The method as claimed in claim 17,
wherein attaching the single primary electrode or the at least one of the multiple primary electrodes to the movable object comprises attaching the single primary electrode or the at least one of the multiple primary electrodes to the vibrational beam or the reciprocating movable object;
wherein attaching the single secondary electrode or the at least one of the multiple secondary electrodes to the stationary object comprises attaching the single secondary electrode or the at least one of the multiple secondary electrodes to the base supporting the vibrational beam or the holder of the reciprocating movable object; and
wherein the method further comprises arranging the single primary electrode or the at least one of the multiple primary electrodes facing to the single secondary electrode or the at least one of the multiple secondary electrodes.

19. The method as claimed in claim 18, wherein arranging the single primary electrode or the at least one of the multiple primary electrodes facing to the single secondary electrode or the at least one of the multiple secondary electrodes further comprises arranging the single secondary electrode or the at least one of the multiple secondary electrodes between the single primary electrode or the at least one of the multiple primary electrodes to form a structure of interdigital electrodes.

20. The method as claimed in claim 14, wherein the sensor comprises the sensor as claimed in claim 1.
